(19) United States
(12) Patent Application Publication
(10) Pub. No.: US 2018/0185970 A1
(43) Pub. Date: Jul. 5, 2018

(54) ASSEMBLY, KIT AND METHOD FOR SECURING A COVERING TO AN AIR INTAKE FACE

(71) Applicant: Randy Simmons, West Chester, OH (US)

(72) Inventor: Randy Simmons, West Chester, OH (US)

(21) Appl. No.: 15/906,086

(22) Filed: Feb. 27, 2018

Related U.S. Application Data
(63) Continuation-in-part of application No. 14/930,728, filed on Nov. 3, 2015.
Application No. 14/930,728 is a continuation-in-part of application No. 14/841,433, filed on Aug. 31, 2015, now Pat. No. 9,561,456.
Application No. 14/841,433 is a continuation-in-part of application No. 13/296,616, filed on Nov. 15, 2011, now abandoned.
Application No. 13/296,616 is a continuation-in-part of application No. 13/205,908, filed on Aug. 9, 2011, now abandoned.

(51) Int. Cl. B23P 19/04; B01D 46/00; B01D 46/10

(52) U.S. Cl. CPC B23P 19/04; B01D 46/0005; B01D 2265/025; B01D 2265/023; B01D 46/10

(57) ABSTRACT

An assembly, kit and method for installing a covering over an air intake opening in engagement with a surrounding perimeter extending face. A plurality of fasteners are provided which can be directly secured to an air intake face, such by utilizing either of magnets or adhesives. These include each of twist and toggle lock fasteners in which a magnet or adhesive is incorporated into a base of the fastener. A further fastener variant incorporates a rigid stem with a compressible or deflectable upper enlarged head which can be resistive fitted during insertion through a grommet aperture in the filter screen outer perimeter and, once passing through the grommet, subsequently re-expanding to hold the screen in place.

### CROSS-REFERENCE TO RELATED APPLICATIONS

This application is a continuation in part of U.S. Ser. No. 14/930,728, filed Nov. 3, 2015. The '728 application is a continuation in part of U.S. Ser. No. 14/841,433 filed Aug. 31, 2015, now U.S. Pat. No. 9,561,456. The '433 application is a continuation in part of U.S. Ser. No. 13/296,616 filed on Nov. 15, 2011. The '616 application is a continuation in part of U.S. Ser. No. 13/205,908 filed on Aug. 9, 2011, now abandoned.

### FIELD OF THE INVENTION

The present invention is directed to an assembly for securing any of a filter screen or other covering (clear or opaque) to a perimeter extending face surrounding a central opening of an air intake structure, such as further including but not limited to any piece of conventional HVAC equipment. A variety of fasteners are provided which can be directly secured to an air intake face using either of magnets or adhesives. These include each of twist and toggle lock fasteners in which a magnet or adhesive is incorporated into a base of the fastener. A further fastener variant incorporates a rigid stem with a compressible or deflectable upper enlarged head which can be resistive fitted during insertion through a grommet aperture in the filter screen outer perimeter and, once passing through the grommet, subsequently re-expanded to hold the screen in place.

### BACKGROUND OF THE INVENTION

Filter screen assemblies, such as utilized for covering an intake opening associated with an air handling unit, are known. Such screens are usually either affixed to the surrounding fascia extending around a perimeter of the intake opening, suspended from a curtain rod extending over the opening, or secured in some other fashion. Examples drawn from the prior art include such as U.S. Pat. No. 7,323,028, U.S. Pat. No. 7,842,116, U.S. Pat. No. 7,416,577, and U.S. Pat. No. 5,370,722, all to Simmons.

Notably among these is the air intake filter screen assembly of U.S. Pat. No. 7,323,028 which includes sub-variants of FIGS. 9-11 and 12-13 which depict both twist lock and toggle lock fasteners which are screwed to the exterior of the air intake face surrounding the opening and prior to receiving grommet or ring defining apertures incorporated into an attachable covering.

U.S. Pat. No. 8,726,954, also to Simmons, teaches a windguard covering, such as for protecting a condenser coil during cold weather seasons. As with the '028 reference, each of toggle fasteners (FIGS. 5-6 and 10-11) and twist lock fasteners (FIGS. 7-9) are provided which are secured to the air intake surface for receiving aperture defining eyelets configured in the perimeter of the attachable covering.

Stayput Fasteners Australia teaches a variety of fabric retaining fasteners, such as for engaging to a fiberglass or other supporting surface, notably for marine applications, and including a linear notch defined in an extending post, such in turn seating and pivotally supporting a rotatable tongue shaped retaining element which is further described as a nickel brass plated component.

Other fasteners are known which can include a magnetic adhering base. A first example of this is the magnetic filter fastener of Sandberg, US 2017/0254562 for removably securing sheeting to a support surface, such as an HVAC system or other device. The fastener includes a base, a rare-earth magnet to removably couple the base to the support surface. As further described, the rare-earth magnet has an epoxy coating and is capable of securing the base to a pre-selected location on the support surface. A locking member pivotally couples to the base and is adjustable between a selectable first position and a second position, wherein the locking member remains in the selected position unless acted upon by a user.

Stokes, U.S. Pat. No. 9,328,754 teaches a fastener for removable attaching a filter material to a mounting structure and including a base and a corresponding and separately engaging safety retainer. The base includes an elongate shaft having a first end for removably attaching the fastener to the mounting structure, such including a magnet incorporated into the base. The separate safety retainer is further configured to be removably received onto the shaft, such as by inserting the tip of the shaft through the hollow central sleeve configured in the interior cavity of the safety retainer which is further defined by an annular extending skirt, and to secure at least a portion of the filter material between the safety retainer and the base.

A further related non-patent commercial disclosure, entitled Sto-Klips high powered adjustable magnetic fastener, discloses a magnetic base and triangular shaped safety retainer which appears to replicate that depicted in FIGS. 9-10 of the Stokes, U.S. Pat. No. 9,328,754 reference.

### SUMMARY OF THE INVENTION

The present inventions disclose an assembly/system, kit and related method for either permanently or releasably securing any combination of elongated supports to a perimeter defining face associated with an air intake. A plurality of fasteners are provided which can be directly secured to an air intake face, such by utilizing either of magnets or adhesives. These include each of twist and toggle lock fasteners in which a magnet or adhesive is incorporated into a base of the fastener. A further fastener variant incorporates a rigid stem with a compressible or deflectable upper enlarged head which can be resistive fitted during insertion through a grommet aperture in the filter screen outer perimeter and, once passing through the grommet, subsequently re-expanding to hold the screen in place.

The attachable filter screen exhibits either of a naked (non-reinforced) or reinforced perimeter, within which is configured a plurality of edge extending apertures and/or grommets, through which projects the extending portion of the desired fastener upon the screen being applied over the centrally defined intake opening. The screen can also include any covering (clear, opaque or otherwise) not limited to filtration. Yet additional variants contemplate the application of this technology to window, doorway (i.e. such as standard and larger garage door type entranceways) or any other suitable opening which it is desirous to cover in the manner described herein.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an exploded view of the assembly according to a first embodiment of the present invention and exhibiting a single pair of upper and lower horizontal extending and fascia supporting rails to which a filter screen is secured by the associated bolt fasteners;

FIG. 2 is a view similar to FIG. 1 of a system according to a second embodiment with first horizontal and second vertical pairs of intake face mounted rails;

FIG. 3 is a side cutaway view in exploded fashion of a pre-assembly location of a selected bolt fastener, rail location, screen with reinforced edge located grommet, washer and wing nut;

FIG. 4 is a succeeding assembly location of the components depicted in FIG. 3;

FIG. 5 is a perspective illustration of an initial pre-assembly step including the installation of a plurality of bolt head fasteners into the modified “U” shaped and fascia attachable rails with threaded shafts projecting through an outwardly facing narrowed slot;

FIG. 6 is a succeeding assembly stage to FIG. 5 in which the perimeter edge extending filter screen grommets are seated upon the projecting shafts and at which the washers and wing nuts are attached;

FIG. 6A is a partially exploded perspective of a modification of the assembly of FIG. 6 and showing an arrangement of twist caps in use with the fasteners of FIG. 5;

FIG. 6B is a partial plan cutaway of a selected engagement established between a bolt, twist cap and modified washer with threaded interior collar against first and second surfaces of the filter screen or other supported covering;

FIG. 6C is a view similar to FIG. 6A of a related variant in which a modification of the outer twist cap integrates a threaded bolt, the bolt fasteners of FIG. 6A being removed and substituted by a reconfigured washer with threaded central support collar which is repositioned within the track following intermediate assembly with the twist cap and interposed filter;

FIG. 6D is a partial plan cutaway of a selected engagement established between the modified screw cap and track insertable washer of FIG. 6C against first and second surfaces of the filter screen or other supported covering;

FIG. 7 is an exploded illustration similar to FIG. 2 of a further embodiment incorporating a plurality of reconfigured and channel rail mounted twist lock fasteners;

FIG. 7A is an enlarged perspective of a modified twist lock fastener exhibiting a lengthened fixed support portion for accommodating any of thicker filter screens, multiple layer screens, or other coverings;

FIG. 8 is an enlarged, assembled and corner perspective of the embodiment of FIG. 7 and illustrating a selected corner located twist lock fastener in an engaged position relative to an outer receiving location of the outer covering;

FIG. 8A is an illustration similar to FIG. 8 of a variant of the twist lock fastener for supporting a dual layer screen upon a selected elongated support track;

FIG. 9 is a side view corresponding to FIG. 4 in the preceding embodiment illustrating the configuration of the selected twist lock fastener of FIG. 8 in engagement with the screen;

FIG. 9A is a corresponding side view of the twist lock fastener of FIG. 8A in engagement with the dual layer screen;

FIG. 10 is another exploded illustration similar to FIG. 7 of a yet further embodiment incorporation a plurality of reconfigured and channel rail mounted toggle lock fasteners;

FIG. 10A is a perspective of a variant of a toggle lock fastener;

FIG. 10B is a perspective of a further variant of a toggle lock fastener exhibiting a lengthened fixed support portion for accommodating any of thicker filter screens, multiple layer screens, or other coverings;

FIG. 11 corresponds to FIG. 8 and illustrates a selected corner located toggle lock fastener in engaged position relative to an outer receiving location of the outer covering;

FIG. 12 corresponds to FIG. 9 and illustrates the configuration of the selected toggle lock fastener in engagement with a filter screen;

FIG. 13 is an exploded illustration of a yet further embodiment incorporating a plurality of reconfigured and channel rail mounted hook fasteners;

FIG. 14 is an enlarged, assembled and corner perspective of the embodiment of FIG. 13 and illustrating a selected corner located hook supporting fastener in an engaged position relative to an outer receiving location of the outer covering;

FIG. 15 is an exploded illustration of a yet further embodiment incorporating a plurality of reconfigured and carabiner type fasteners;

FIG. 16 is an enlarged, assembled and corner perspective of the embodiment of FIG. 15 and illustrating a selected corner located carabiner supporting fastener in an engaged position relative to an outer receiving location of the outer covering;

FIG. 17 is an environmental view of a further application of fastener and channel rail mounted assembly applied over an enlarged garage door type opening;

FIG. 18 is a yet further environmental view of a yet further application applied over a window type opening;

FIG. 19 is a partially exploded perspective of a further variant of the assembly and illustrating a plurality of modified elongated track defining supports secured to the air intake face surrounding the central opening;

FIG. 20 is a cross sectional cutaway of a selected track support from FIG. 19 and illustrating an underside positioned magnet for assisting in releasably securing the support in extending fashion along a metal receiving surface of the intake face;

FIG. 21 is an illustration of a selected twist lock fastener utilized in the engagement protocol of FIG. 20 and exhibiting widened base support locations for facilitating frictional and positional fitting within the interior track defining sides of the support;

FIG. 22 is a cross sectional cutaway of a selected track support as previously shown in FIG. 20 and illustrating a variant of the twist lock fastener;

FIG. 23 is an illustration of the modified twist lock fastener, similar to that shown in FIG. 21, and exhibiting a lengthened fixed support portion for accommodating any of thicker filter screens, multiple layer screens, or other coverings;

FIG. 24 is a partially exploded view of a support track according to a modification of FIG. 19 and which includes the provision of intermediate end-to-end and corner/angled adaptors or plugs for assembling running lengths of support track in varying arrangements upon the air intake face;

FIG. 24A is a similar illustration to FIG. 24 and showing a variant of the corner adaptors/plugs for providing the assembled support track with a seamless edge appearance;

FIGS. 24B-24C respectively illustrated exploded and assembled views of a further three sided variant of linear end-to-end adaptor which is configured to attached abutting opposing ends of first and second selected running lengths of support track;

FIG. 25 is a partial corner depiction of a further joining arrangement established between perpendicular arranged support track and having a mitered appearance;

FIG. 26 is a corresponding corner depiction showing the modified corner adaptors of FIG. 24A;

FIG. 27 is a further variant of a three dimensional triangular enclosure utilized with any variant of corner plug/adaptor and for providing additional structural support between angled extending ends of support track;

FIG. 28 is an illustration of a further variant of screen attached grommet in the form of a two-piece sandwich configuration for inter-engaging through opposite sides of a reinforced corner location of an associated screen;

FIG. 29 is a further partially exploded plan view of the assembled screen grommet of FIG. 28 in combination with the toggle lock fastener of FIGS. 20-21;

FIG. 30 is an illustration similar to FIG. 28 and depicting an unreinforced screen utilized in combination with the two piece assembleable grommet;

FIG. 31 is a further partially exploded plan view of the assembled screen grommet of FIG. 30 in combination with the toggle lock fastener of FIGS. 20-21;

FIG. 32 is a cutaway plan illustration of a selected track support and depicting a two-sided adhesive tape backing for securing the support to an intake face location;

FIG. 33 is a similar plan illustration of the magnetic backing of FIG. 20 for securing the track support of FIG. 32 to the intake face location;

FIG. 34 is a further plan illustration similar to FIGS. 32-33 of a glue for attaching the track support to the intake face location;

FIG. 35 is a yet further plan illustration of a screw passing through an aperture in the base of the track support for mounting to the intake face location;

FIG. 36 is a front plan illustration of a square support track arrangement in combination with the triangular three dimensional corner supports of FIG. 27;

FIG. 37 is a front plan view similar to FIG. 36 of a rectangular support track arrangement;

FIG. 38 is a further front plan view of a triangular support track arrangement;

FIG. 39 is a kit illustration depicting a plurality of support tracks, stock filter, assembleable grommets, and twist lock fasteners (FIG. 21), according to one non-limiting variant of the present inventions;

FIG. 40 is an exploded view of a rigid lattice style mesh provided in combination with the intake face mounted track mount kit and the overlaying screen according to a further non-limiting embodiment;

FIG. 41 is an enlarged partial perspective of the variant of FIG. 40 and further illustrating the rigid lattice style mesh in a partially assembled condition overlaying the projecting threaded shafts of the associated bolt fasteners pre-positioned within the extending tracks mounted to the intake face;

FIG. 42 is a side cutaway illustration of a fully assembled rigid mesh and overlaid screen relative to the air intake face and engaging fasteners;

FIG. 43 is a further side cutaway of a variant of FIG. 42, and in which a second inwardly positioned support track is secured to the intake face and separately secures the rigid mesh;

FIG. 44 is a further side cutaway of a variant similar to FIG. 42 and illustrating a different fastener arrangement with a twist knob with threaded projecting stem provided in combination with a reconfigured and interiorly threaded nut having an outer rubberized and gripping coating and which is inserted through the open end of the support track;

FIG. 45 is a modification of the variant of FIG. 44 and depicting a further mounting arrangement utilizing only the rigid mesh component;

FIGS. 46-47 respectively illustrate perspective and top plan views of a fastener according to a further preferred embodiment which is adapted to being directly mounted to an air intake face surface in a further application of the present invention, the fastener further depicting one variant of a partially to fully rigid retention post in combination with an enlarged and deflectable retention head for resistively seating through and subsequently over the ring or grommet configured into the filter cover;

FIG. 48 is a plan cutaway of the fastener of FIG. 46 and illustrating a magnet integrated into an underside of a supporting base of the fastener, such as which can include an underside cavity for receiving the magnet;

FIG. 49 is an alternate plan cutaway to FIG. 48 and illustrating a durable adhesive layer integrated into an underside of the fastener base, such including a surface peel-away layer to assist in mounting to the intake face;

FIGS. 50-51 respectively illustrate perspective and top plan views of a fastener according to a further preferred embodiment which is adapted to being directly mounted to an air intake face surface in a further application of the present invention, the fastener further depicting a twist lock fastener for inserting through and subsequently retaining over and against a ring or grommet configured into the filter cover;

FIG. 52 is a plan cutaway of the fastener of FIG. 50 and illustrating a magnet integrated into an underside of a supporting base of the fastener;

FIG. 53 is an alternate plan cutaway to FIG. 52 and illustrating a durable adhesive layer integrated into the underside of the fastener base, such including a surface peel-away layer to assist in mounting to the intake face;

FIGS. 54-55 respectively illustrate perspective and top plan views of a fastener according to a further preferred embodiment which is adapted to being directly mounted to an air intake face surface in a further application of the present invention, the fastener further depicting a toggle lock fastener for inserting through and subsequently retaining over and against a ring or grommet configured into the filter cover;

FIG. 56 is a plan cutaway of the fastener of FIG. 54 and illustrating a magnet integrated into an underside of a supporting base of the fastener;

FIG. 57 is an alternate plan cutaway to FIG. 56 and illustrating a durable adhesive layer integrated into the underside of the fastener base, such including a surface peel-away layer to assist in mounting to the intake face;

FIGS. 58-59 illustrate a pair of cutaway plan views which, in comparison to those previously shown in FIGS. 48-49, depict a further kit variation of the present invention in which either of magnet or adhesive mounting components can be provided separately for engagement to the underside of the fastener;

FIG. 60 is an illustration of a template sheet which can be provided according to a further variant of the present invention, such including perimeter markings which replicate that of the grommet pattern associated with the covering, and which can be used to mark locations for attaching the fasteners according to any of the present embodiments;

FIGS. 61-62 respectively illustrate perspective and top plan views of a fastener according to a further preferred embodiment which is adapted to being directly mounted to an air intake face surface in a yet further application of the present invention, the fastener further depicting another variant, in comparison to that shown in FIG. 46, of a partially to fully rigid retention post in combination with an enlarged and controlled collapsible retention head for resistively seating through and subsequently re-expanding over the ring or grommet configured into the filter cover;

FIG. 63 is a plan cutaway of the fastener of FIG. 62 and illustrating a magnet integrated into an underside of a supporting base of the fastener, such as which can include an underside cavity for receiving the magnet;

FIG. 64 is an alternate plan cutaway to FIG. 61 and illustrating a durable adhesive layer integrated into an underside of the fastener base, such including a surface peel-away layer to assist in mounting to the intake face;

FIGS. 65-66 depict a pair of plan cutaway environmental views of the fastener of FIG. 46 in each of an intermediate deflecting collapse/inserting position (FIG. 65) and subsequent pass through return expanded position (FIG. 66) for seating through an aperture defining grommet or ring configured at a perimeter location of the attachable screen or covering;

FIGS. 67-68 depict a pair of plan cutaway environmental views of the fastener of FIG. 61 in each of an intermediate compression collapse/inserting position (FIG. 67) and subsequent pass through and re-expanded position (FIG. 68) for seating through an aperture defining grommet or ring configured at a perimeter location of the attachable screen or covering; and

FIGS. 69-71 illustrate a series of top plan views of three non-limiting examples of modified ellipsoidal, rectangular and triangular collapsible heads integrated into fasteners in comparison to that depicted in FIG. 47.

### DETAILED DESCRIPTION OF THE PREFERRED EMBODIMENTS

As will be further described with reference to the succeeding illustrations, the present invention discloses a system/assembly, kit and method of assembling a plurality of track supports with to a surrounding fascia associated with an air intake opening, these in combination with a variety of screens/coverings, fasteners for supporting the screen on the assembled supports, and optional end-to-end and corner adaptors/plugs for arranging the track supports according to any desired orientation. As will be explained in further detail, the present invention enables attachment of any number of the support tracks to the face of air handling mechanical equipment, this including the use of magnets to accomplish releasable attachment of the elongated supports to the surface of the air intake face. Other variants contemplate any of adhesives, including two sided tape or glue, as well as conventional fasteners (screws, bolts, etc.) for securing the track supports to the intake face.

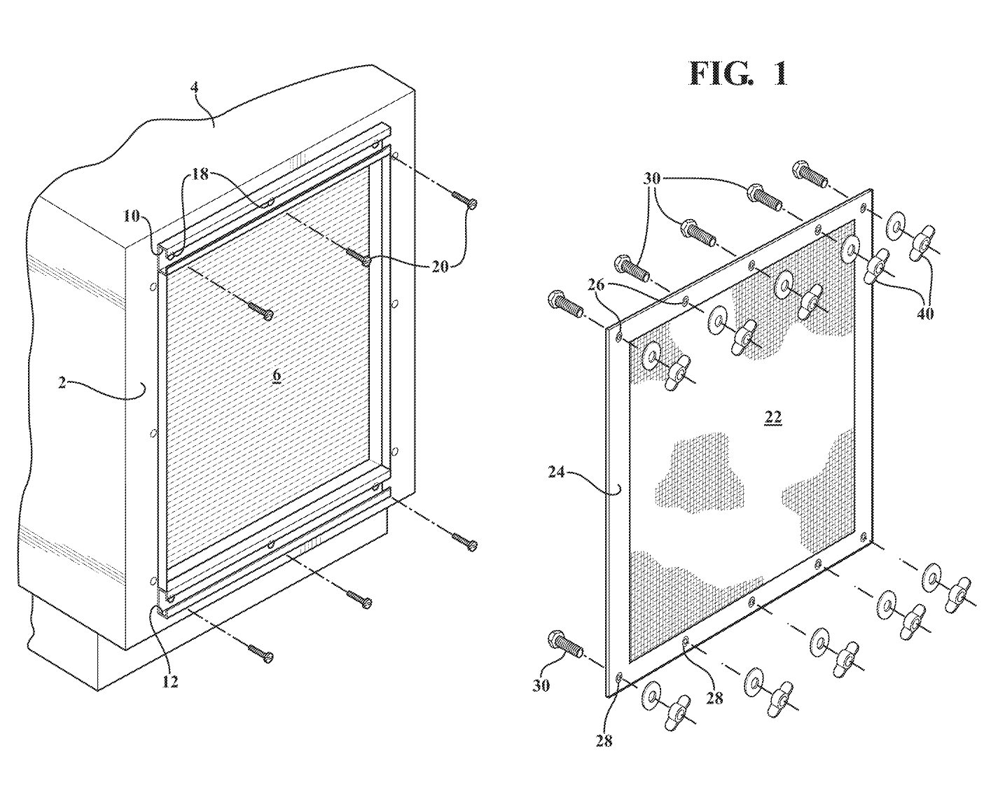

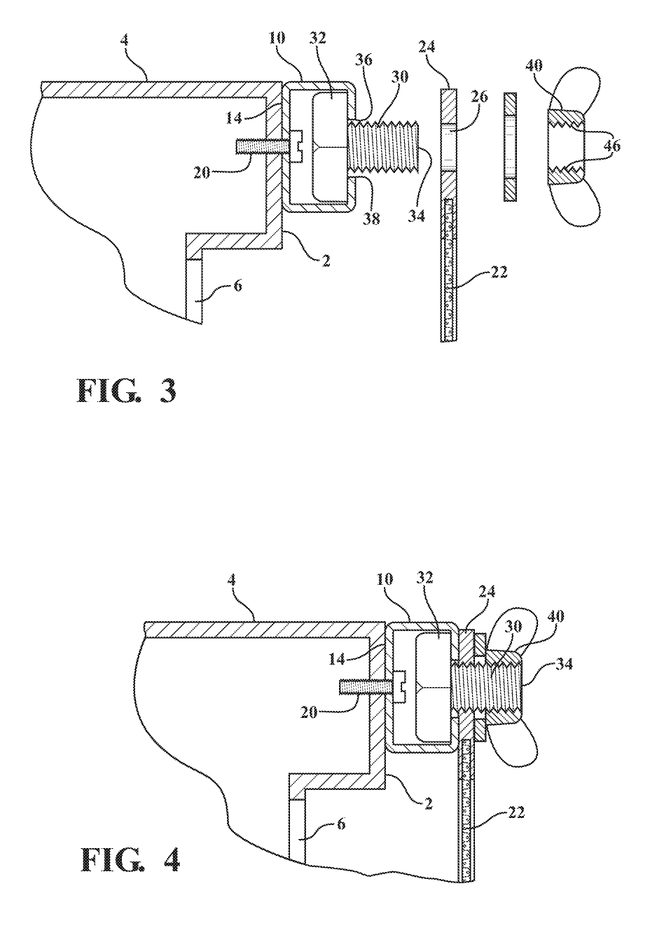

Referring to FIG. 1, an exploded view is generally depicted of the channel lock filter fastening system according to a first embodiment of the present invention and exhibiting a single pair of upper and lower horizontal extending and fascia supporting rails, see at 10 and 12, which are secured at extending locations along a fascia surface 2 associated with an air intake structure 4 (such further understood to include any suitable type of air handling mechanical equipment not limited to air conditioner condenser units, cooling towers etc.). As further depicted in each of succeeding views FIGS. 3-6, each of the rails (see for example first upper horizontal extending rail 10) exhibits a three dimensional, and typically modified “U”, shape with a base surface (see at 14 in each of FIGS. 3-6).

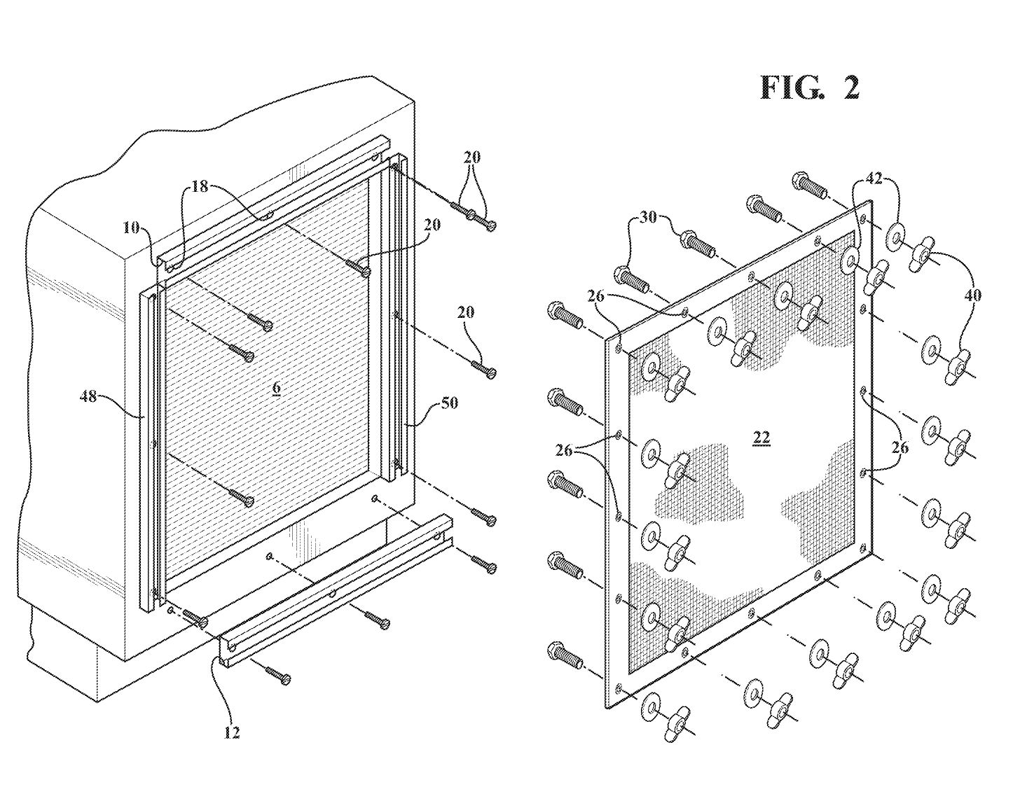

A plurality of spaced apart apertures are defined by inner perimeter extending circular edges 18 (see again rail 10 in each of FIGS. 1 and 2). A plurality of screw fasteners 20 are provided and insert through the circular apertures in order to fasten the rails 10 and 12 in horizontal and parallel extending fashion above and below an intake opening or area which is further generally designated at 6 in each of FIGS. 1-4.

A filter screen 22 is provided, typically exhibiting a flexible mesh like material and including a surrounding reinforced outer portion 24. First 26 and second 28 pluralities of grommets (such interpreted to include metal ringlets or the like which are molded, press fit or otherwise affixed), extend along top and bottom outer hem extending locations of the reinforced outer portion 24.

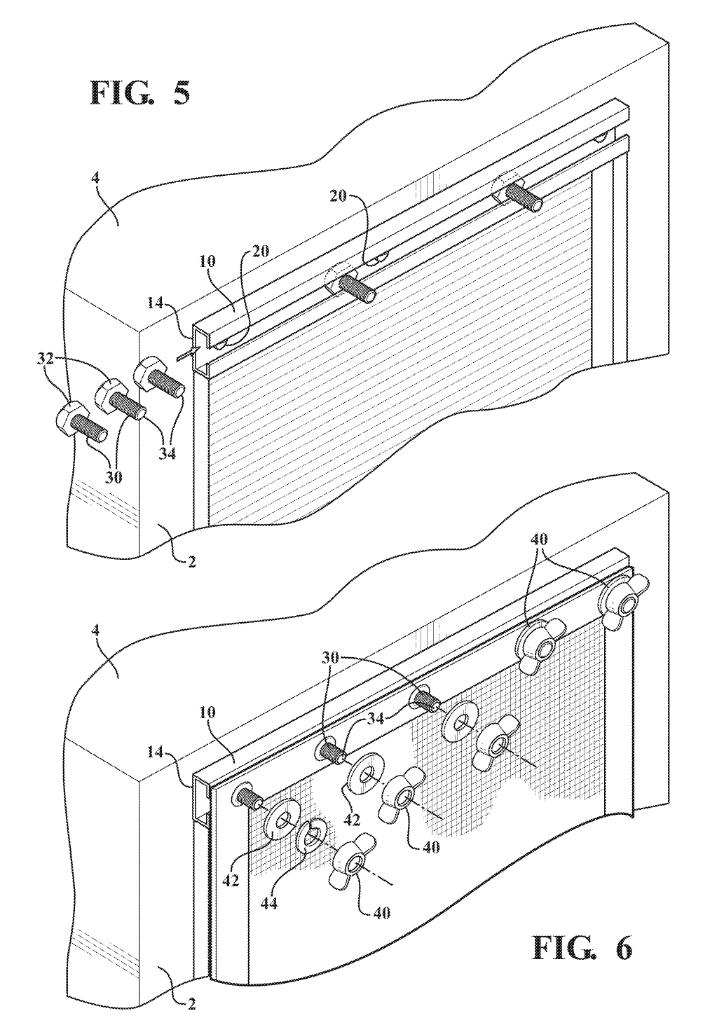

A plurality of bolt fasteners 30 are provided and are identical in construction as with the various edge extending grommets or screw fasteners. As best shown in FIGS. 3-6, an enlarged head 32 (typically hexagonal shaped) is dimensioned so that it establishes a minor degree of clearance with the inner extending edges of the associated channel defined in the selected rail 10. This facilitates the bolts 30 to be successively installed through an open accessible end of the rail 10 (see FIG. 5) and traversable along the channel interior to desired intermediate locations, and with an end 34 of each bolt shaft projecting beyond a slot (see walls 36 and 38 in partially exploded view of FIG. 3) defined in a forward spaced projecting edge of the rail.

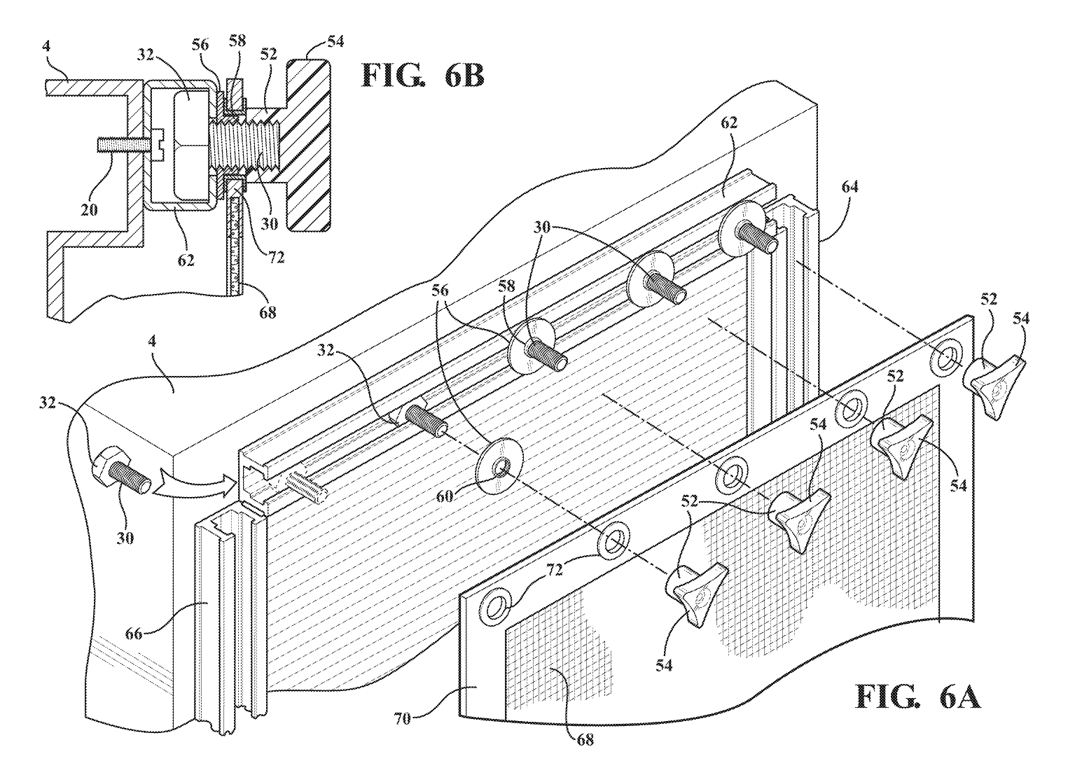

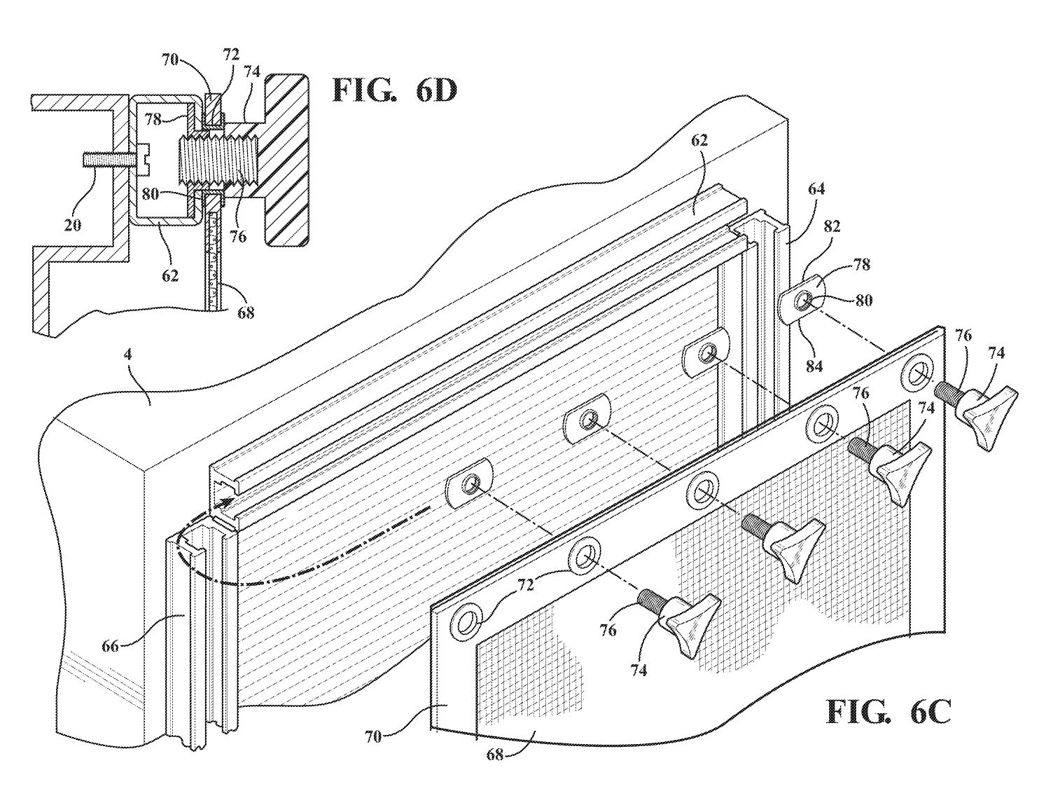

At this point, and viewing FIGS. 1, 4 and 6 collectively, the filter screen 22 is applied such that the ringlets 26 are successively seated over the projecting shaft ends 34, following which a plurality of nuts, by non-limiting example depicted as wing nuts 40, are applied over the exposed shaft ends and are rotated into a tightening arrangement in order to secure the filter screen to the rails 10 and 12. Also depicted are a plurality of washers 42 (see FIG. 6) this also contemplating the additional or alternate use of lock washers (further at 44 in FIG. 6) and so as to prevent the filter from becoming inadvertently loosened from the intake structure fascia.

Alternative to separately provided washers/lock washers, it is also envisioned that suitable washer/lock washer portions can be integrally formed into the wing nut (or other nut) construction. It is further envisioned that, referring to FIG. 3, a suitable nylon coating 46 can be applied to the inner threads associated with each wing nut 40 and which can be accomplished both in combination or alternate the incorporation of any type of separately utilized or integrally formed lock washers. It is further understood that the configuration and dimensioning of the enlarged bolt heads is such that, during twisting application of the nuts 40, the heads 32 do not turn or rotate within the channels (see again FIGS. 3 and 4), such otherwise impeding the ability to quickly apply or remove the nuts 40.

FIG. 2 is a view similar to FIG. 1 of a system according to a second embodiment which differs only to the extent that it adds a second vertical pair of intake face mounted rails 48 and 50 applied to opposite and vertically extending sides of the fascia 2 in such a fashion that the first (10 and 12) and second pairs (48 and 50) of rails collectively establish a generally rectangular shape (this including a square shape in the instance in which the sides of the intake opening and the lengths of all the rails are co-equal). Otherwise, the filter 22 is as previously disclosed in claim 1 with the corresponding modification to include additional grommets 26 likewise extending along the vertical side edges of the reinforced outer frame (also hem or skirt) with corresponding additional bolts 30, wing nuts 40 and washers 42 likewise being provided so as to progressively secure the filter 22 along each of four interconnecting edges and as opposed to only two upper and lower edges as is the case in the illustration of FIG. 1. Such an assembly option as depicted in FIG. 2 contemplates, without limitation, that the bolts, nuts and washers associated with the upper rail 10 are first assembled, following which the sides 48 and 50 are progressively assembled such as further by individually supporting the bolts within the vertical channels during progressive assembly of the nuts and washers. That said, the present invention does not preclude or limit any particular assembly protocol or sequence beyond that which is possible owing to the structural aspects of the design.

Referring now to FIG. 6A, a partially exploded perspective of a modification of the assembly of FIG. 6 and showing an arrangement of twist caps 52 in use with the fasteners (threaded shafts 30 which are also termed “snug nuts” as well as an equal number of hex heads 32) of FIG. 5. The twist caps depict collars which are interiorly threaded from an open inner end (not shown) and further each include a triangular (or other suitable and polygonal) shaped gripping end 54. The caps 52 are further constructed of a plastic or other suitable material.

As additionally shown in FIG. 6B, an equal plurality of modified washers 56 are provided, each of these including a protuberant collar 58 defining an interiorly threaded profile 60. The bolts (hex head 32 and stem 30) are pre-installed into an open channel end defined in a modified support track (see at 62, 64 and 66 in FIG. 6 arranged about the intake opening of the associated structure 4) and so that the threaded stems 30 projecting through the front disposed slot in the manner depicted. The elongated track supports are similar in application to those previously disclosed at 10 and 12 in FIG. 1 and can include a slightly modified extrusion profile and, as will be further described, can be attached both to the face of intake structure and interconnected in end-to-end fashion according to a variety of different configurations.

A flexible ply material or covering, such as any screen or mesh utilized in a filtration application or an opaque covering in the instance of a sealing or winterizing application, is provided at 68. The material may include a reinforced outer perimeter 70 and can further exhibit a plurality of reinforced ringlets 72 (also termed grommets) integrated into the outer perimeter of the material. In application, and as again referenced in the partial plan cutaway of FIG. 6B, a selected engagement is established between a bolt, twist cap and modified washer with threaded interior collar against first and second surfaces of the filter screen or other supported covering 68.

FIG. 6C is a view similar to FIG. 6A of a related variant in which a modification of the outer twist cap, see at 74 in comparison to as shown at 52 in FIG. 6A) integrates a threaded bolt 76. The bolt fasteners of FIG. 6A are removed in this variant and substituted by a reconfigured washer 78 with threaded central support collar 80. The washers 78 each exhibit linear upper 82 and bottom 84 edges and are dimensioned such that they are insertable through the open end of the track supports 62, 64, 66, et seq.

In practice, and owing to the lack of a projecting component through the front defined and slot accessible face of each track support, the threaded portions 76 of the twist nuts 74 are typically pre-engaged through the material ringlets 72 and the inner threaded collars 80 of the modified/flattened washers in an intermediate assembled fashion, such prior to the washers being installed from the open channel ends of the supports. In this fashion, the twist nuts 74 are used for translating the washers within the supports prior to finished tightening. This is further depicted in FIG. 6D which, similar to FIG. 6B, is a partial plan cutaway of a selected engagement established between the modified screw cap and track insertable washer of FIG. 6C against first and second surfaces of the filter screen or other supported covering. As further shown, the linear edges 82/84 of the modified washers 78 can be dimensioned, if desired, such that they establish a desired friction engagement with the inside channel defining sides of the track supports 62, 64, 66, et seq., this in order to assist in maintaining their position within the supports during completion of installation.

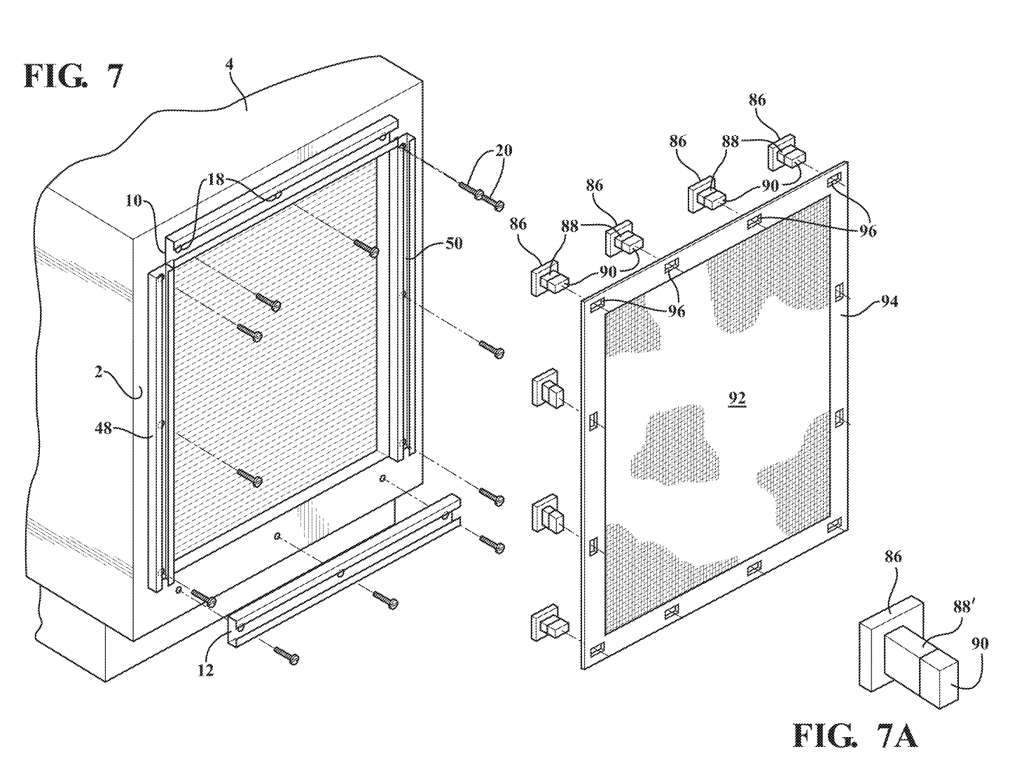

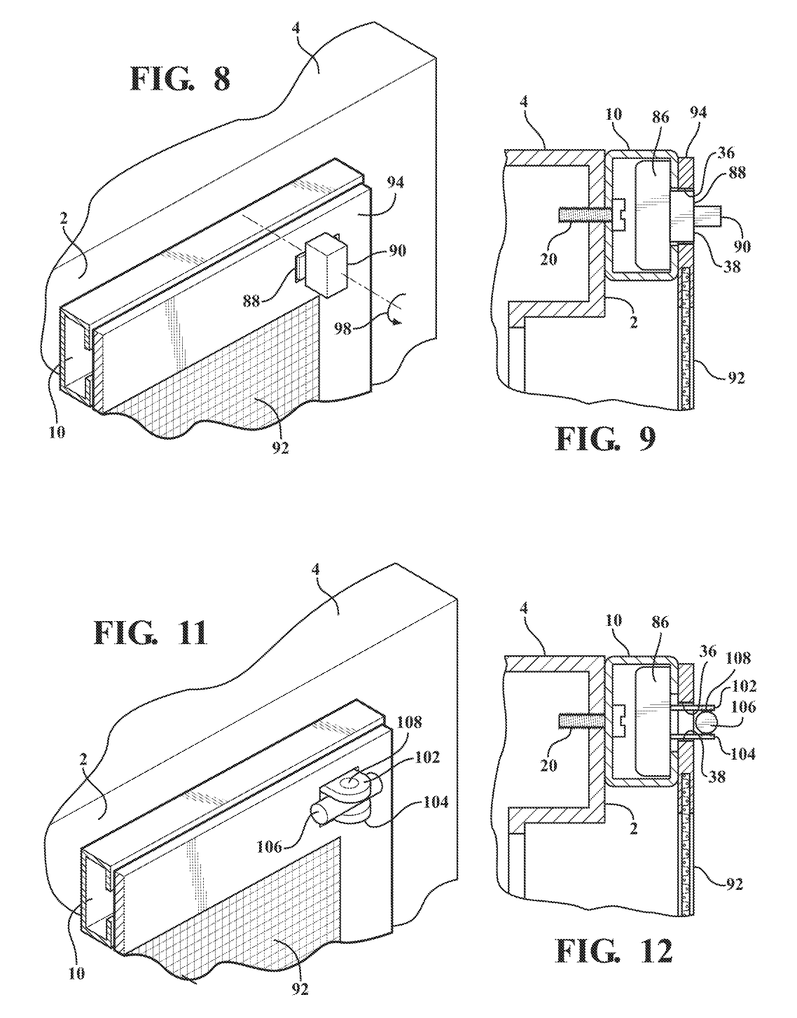

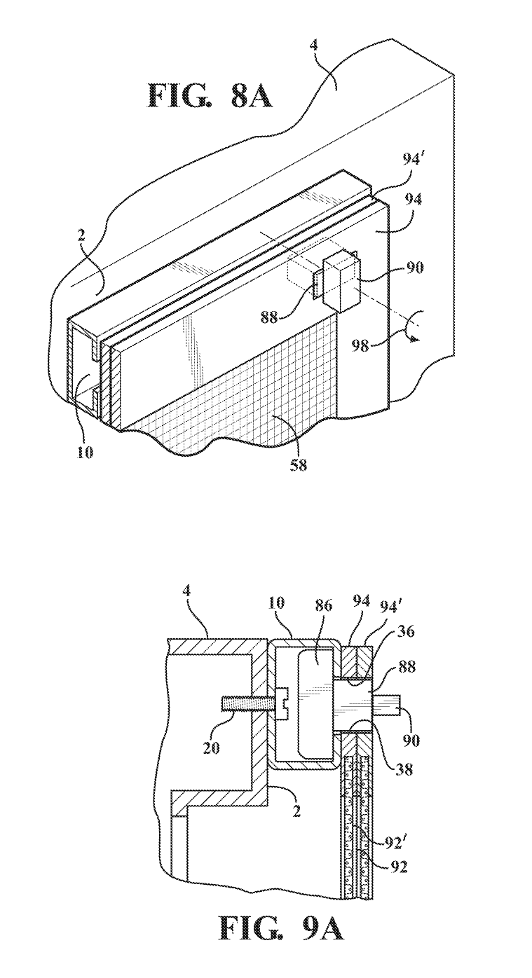

Referring now to FIG. 7, an exploded illustration similar to FIG. 2 of a further embodiment incorporating a plurality of reconfigured and channel rail mounted twist lock fasteners, each of which including a flat rectangular shaped base 86 which is dimensioned for seating in laterally slidable fashion within the open channel interior defined in relation to each rail 10, 12, 48, 50 (as previously described in the preceding embodiments). The inserting base 86 in turn supports a reduced dimensioned fixed portion 88 which in turn seats through the linear slot defined between inner extending walls 36 and 38 (this as best shown in FIGS. 8 and 9 and such that the both the fixed portion 88 and underlying channel seating base 86 are permitted to slide but not rotate relative to the rails). FIG. 7A is an enlarged perspective of a modified twist lock fastener exhibiting a lengthened fixed support portion 88′ extending from the base 86 and for accommodating any of thicker filter screens, multiple layer screens, or other coverings;

A further twist and lock portion 90 is mounted via a pin or stud in a rotatable fashion relative to the fixed support 88. A screen or like covering 92 exhibits a flexible or rigid perimeter extending edge 94 within which is defined an array of perimeter spaced apart rectangular apertures 96 (as opposed to circular apertures 28 depicted in the variant of FIG. 1). Without limitation, the apertures in the covering can also exhibit any other shape or profile.

In this fashion, and upon the twist lock portions being first rotated to a flush profile with the underlying fixed portions 88 (FIG. 7), the fasteners are prepositioned within the rails so that the twist lock portion 90 and the upper part of the underlying fixed portion 88 collectively seat through the apertures 96 (see FIG. 9). At this point, the twist lock portion 90 is rotated ninety degrees about a horizontal axis (see arrow 98 in FIG. 8) and so that an offset portion of the underside of each twist lock portion 88 prevents removal of the covering 92.

FIG. 8A is an illustration similar to FIG. 8 of a variant of the twist lock fastener for supporting a dual layer screen, see at 92 and 92′ with corresponding reinforced edges 94 and 94′, upon a selected elongated support track. FIG. 9A is a corresponding side view of the twist lock fastener of FIG. 8A in engagement with the dual layer screen 94/94′.

In this manner, the various fasteners are capable of being preposition along either or both of first and second opposing pairs of surface mounted rails 10/12 and/or 48/50 in a manner which facilitates quick location, installation and removal of the covering. The covering material 92 can again include any type of screen or mesh as well as also contemplating the use of impermeable covering or insulating materials. It is further envisioned that the outer perimeter or binding 94 of the covering material can include either rigid or flexible materials.

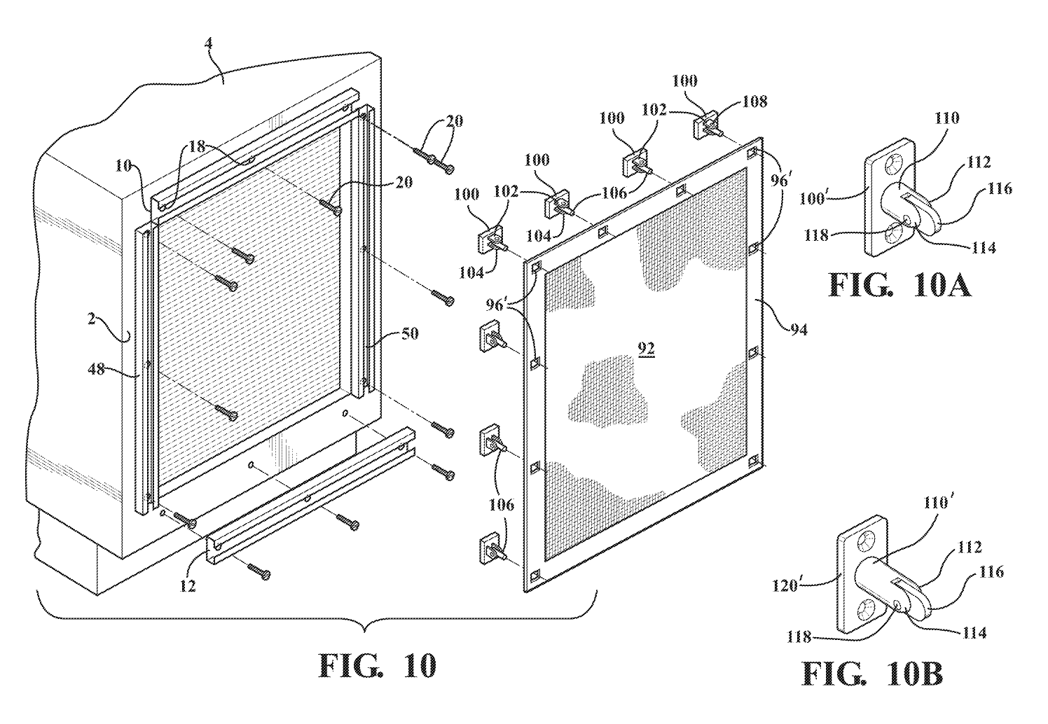

Referring to FIG. 10 in combination with FIGS. 11-12, another exploded illustration similar to FIG. 7 is provided of a yet further embodiment incorporating a plurality of reconfigured and channel rail mounted toggle lock fasteners. Each of the toggle lock fasteners includes a generally flat and rectangular shaped channel seating base 100 of a shape and dimension similar to that previously identified at 86 in regards to the twist lock fasteners of FIG. 7 and such that the toggle lock fasteners can be channel inserted for lateral displacement within the associated surface mounted rails 10/12 and 48/50 (see again FIG. 12) or at 62, 64, 66, et seq. (FIG. 6A).

Each of the toggle lock fasteners further includes a pair of spaced apart tabs 102 and 104 projecting from each base 100 in a manner which permit outermost portions thereof to project beyond the spaced apart channel defining surfaces 36 and 38 associated with each selected rail (and as shown in cutaway in FIG. 12 in relation to selected rail 10). A cylindrical shaped toggle element 106 is mounted about a vertical axis defined by a pin 108 extending widthwise through the toggle and supported to the tabs 102 and 104. In this fashion, the toggle lock fasteners are first pre-positioned within the channel rails 10, 12, 48 and 50, following a modified array of spaced apart apertures 96′ associated with the flexible or rigid binding or perimeter 94 associated with the covering 92 are mounted over the toggle elements in the perpendicular extending positions shown in FIG. 10 relative to the support base 100, following which the toggle elements 106 are rotated to the position of FIGS. 11 and 12.

FIG. 10A illustrates one non-limited example of a substitutable modification of toggle lock fastener as compared to that described in FIG. 10 and in which a pseudo-cylindrical shaped post or body 110 extends from a reconfigured channel seating base 100′ (this including such as dovetail apertures defined therein for receiving other types of mounting fasteners in other applications separate from sliding insertion within the rail channels as described herein). The generally cylindrical shaped body 110 is solid proximate its integral mounting location with the flat and rectangular shaped channel seating base 100′ and includes a pair of extending ears or lobes 112 and 114, these in turn establishing an inner slot or channel having a desired profile for seating therebetween a generally planar, curved edged and rotatable toggle element 116 mounted for rotation between the ears or lobes 112 and 114 via a horizontal pin 118.

The toggle fastener depicted in FIG. 10A is both installed and manipulated in a substantially identical fashion as compared to that in FIG. 10 and it is further envisioned that other variations of either twist or toggle lock fasteners can be employed within the scope of the invention. FIG. 10B is a perspective of a further variant of a toggle lock fastener of FIG. 10A exhibiting a lengthened fixed support portion 110′ for accommodating any of thicker filter screens, multiple layer screens, or other coverings, and such as is again reflected by the dual layer covering arrangement of FIGS. 8A and 9A.

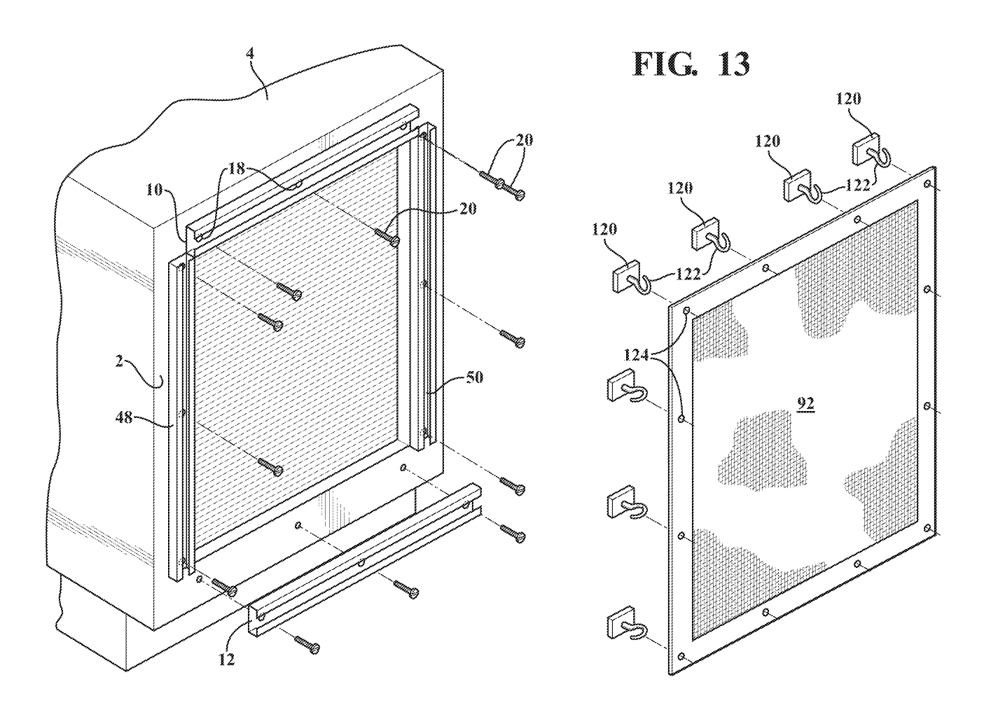

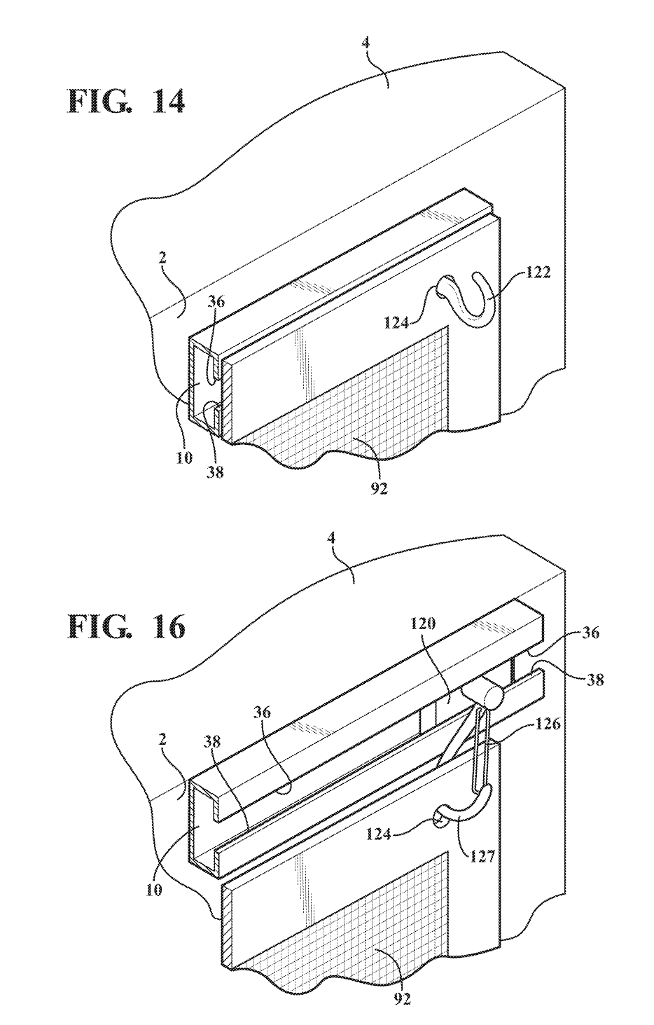

FIG. 13 is an exploded illustration of a yet further embodiment incorporating a plurality of reconfigured and channel rail mounted hook fasteners including base shaped channel rail supports 120 from which project hook shaped elements 122. The covering material 92 exhibits a series of apertures 124 arranged in spaced apart fashion about an outer flexible or rigid perimeter of the covering, such further including reinforced ringlets or grommets (both plastic or metal) for preventing tearing of the binding, with the further understanding that suitable rectangular shaped outer reinforcements can also be integrated into the covering apertures 96 and 96′ depicted respectively in FIGS. 7 and 10. FIG. 14 is an enlarged, assembled and corner perspective of the embodiment of FIG. 13 and illustrating a selected corner located hook supporting fastener 122 in an engaged position relative to an outer receiving location (aperture) 124 of the outer covering 92.

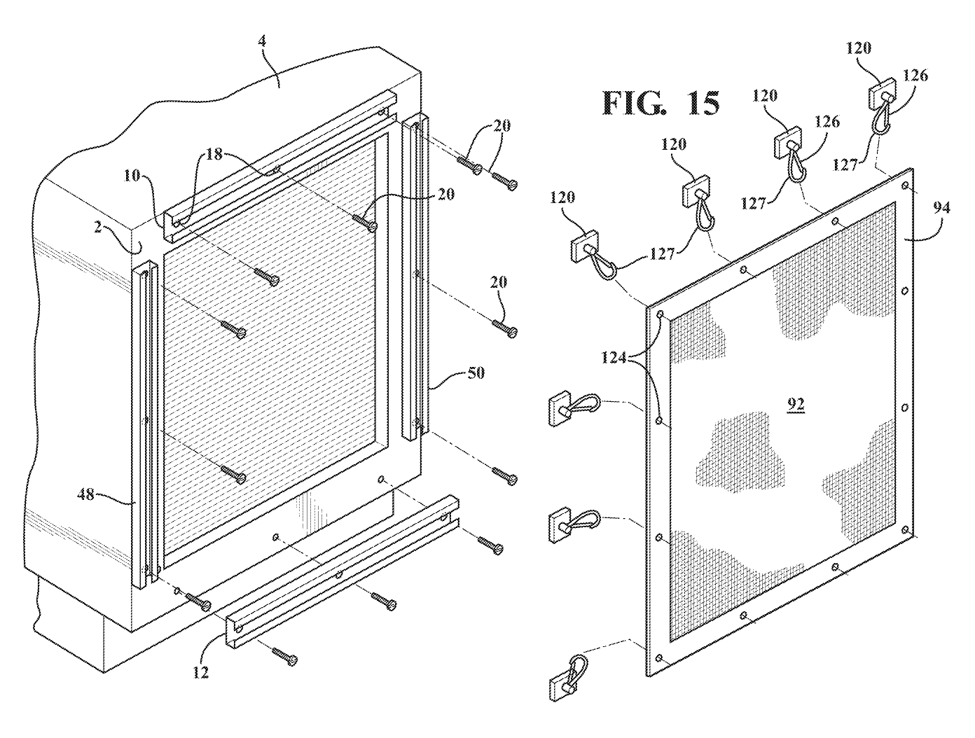

FIG. 15 is an exploded illustration of a yet further embodiment incorporating a plurality of reconfigured and carabiner type fasteners, these including once again insertable planar rectangular base supports 120 from which are pivotally supported individual and spring biasing carabiners 126. FIG. 16 is an enlarged, assembled and corner perspective of the embodiment of FIG. 15 and illustrating a selected corner located carabiner, see spring biased portion 126 pivotal relative to a hook main portion 127, and shown in an engaged position relative to an outer receiving aperture 124 of the reinforced outer covering 94 of the material 92.

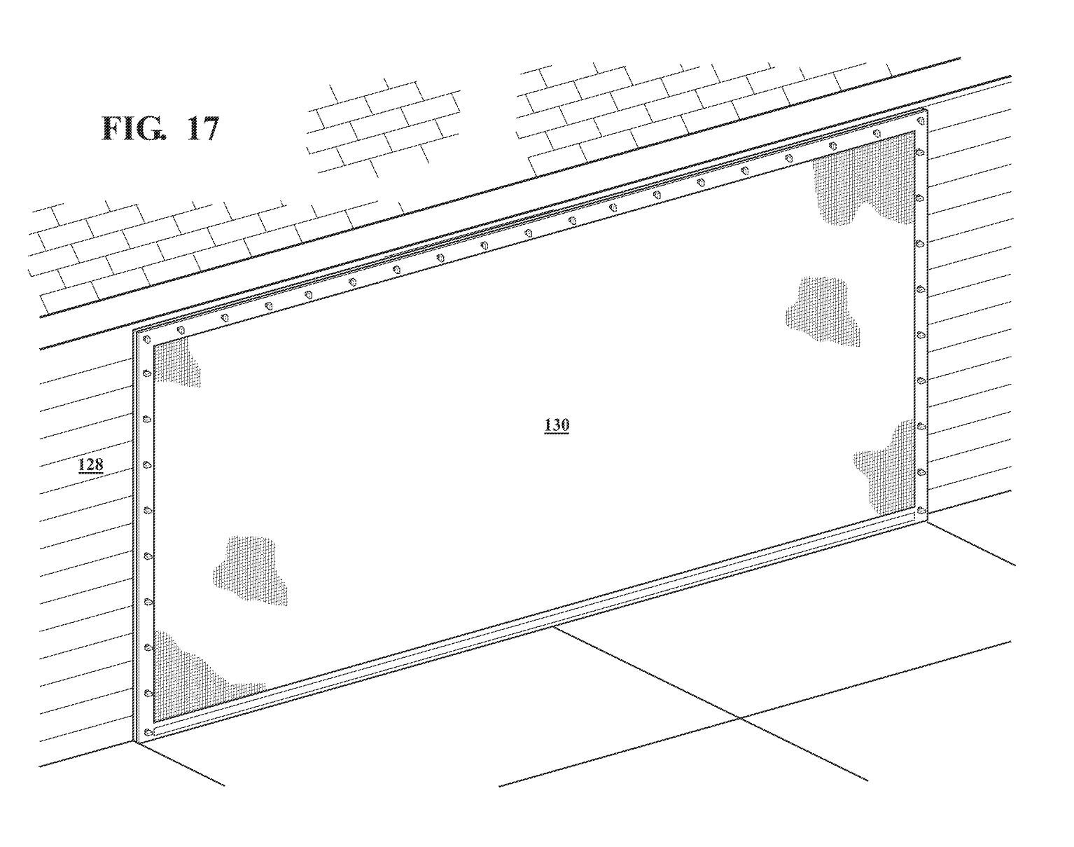

FIG. 17 is an environmental view of a further application of fastener and channel rail mounted assembly (this depicting for exemplary sake the twist lock fasteners 90 previously described in FIGS. 7-9 and which are installed over a plurality of three edge proximate interconnecting channel rails (not shown but generally corresponding to top rail 10 and side rails 48 and 50 with bottom rail 12 deleted) in turn secured to edge proximate extending locations associated with any type of opening (also hidden from view), and such as further depicted as an enlarged garage door or like opening associated with a structure 128. A suitably dimensioned covering material 130 is provided and which can again include any type of breathable mesh or impervious material, about which extends either a flexible or rigid binding or perimeter through which are formed a suitable array of spaced apertures (such as previously depicted at 96 in FIG. 7) for facilitating installation of the material 130.

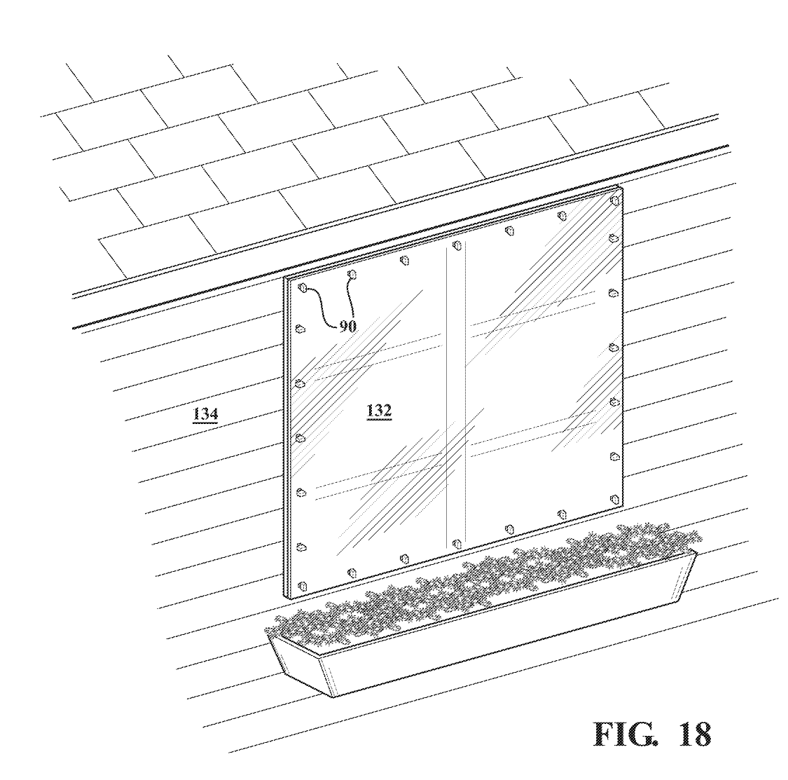

Finally, FIG. 18 is a yet further environmental view of a yet further application of fasteners (again twist lock type fastener 90) applied over a window type opening about which are secured an arrangement of four rails 10, 12, 48 and 50 in the manner previously described. A covering 132 is depicted mounted over the window or like opening (not shown) associated with a structure 134, and which may again possess a similar arrangement of binding edge extending mounting apertures for receiving the individual twist lock portions 90. The covering 132 is further depicted as a plasticized or other impervious material (such further optionally exhibiting transparent or translucent properties) as a winterizing cover and as opposed to alternate use with a seasonal and breathable mesh depicted previously at 92. In this fashion a variety of different covering materials, varying by weight and or construction, can be provided as alternate covering for different seasons (e.g. mesh material in summer and impervious/heavy duty sealing cover for winter).

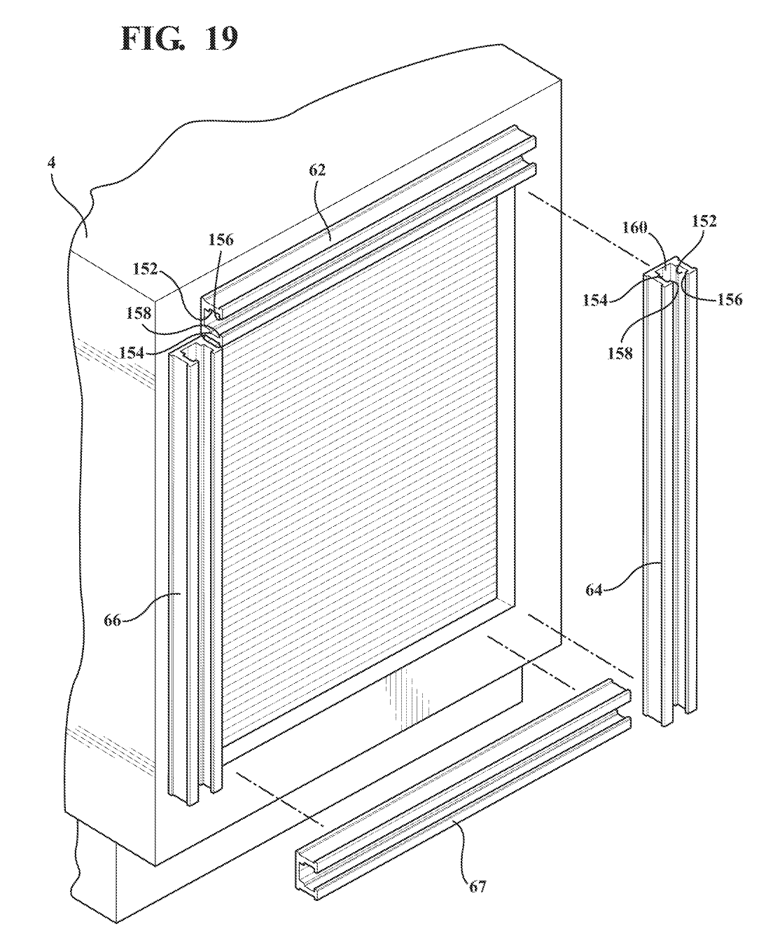

Referring to FIG. 19, a partially exploded perspective is shown of a further variant of the assembly and illustrating the plurality of modified elongated track defining supports previously depicted at 62, 64, 66 (and further at 67), secured to the air intake face of the associated structure 4 surrounding the central opening. As previously described, the track defined supports can exhibit any desired cross sectional shape or profile and may, in one non-limited example, be constructed of an aluminum, plastic or other suitable extruded, stamped or otherwise formed material.

As further shown, the track supports may exhibit a modified “U” shaped inner channel or profile for receiving the inserting portions of the various fastener arrangements for securing the filter or mesh to the arranged track supports. As will also be described and shown in additional detail, the supports have an increased cross sectional thickness, with their cross sectional interior channels exhibiting irregular or stepped surfaces (as compared to the channel supports 10, 12 in FIG. 1).

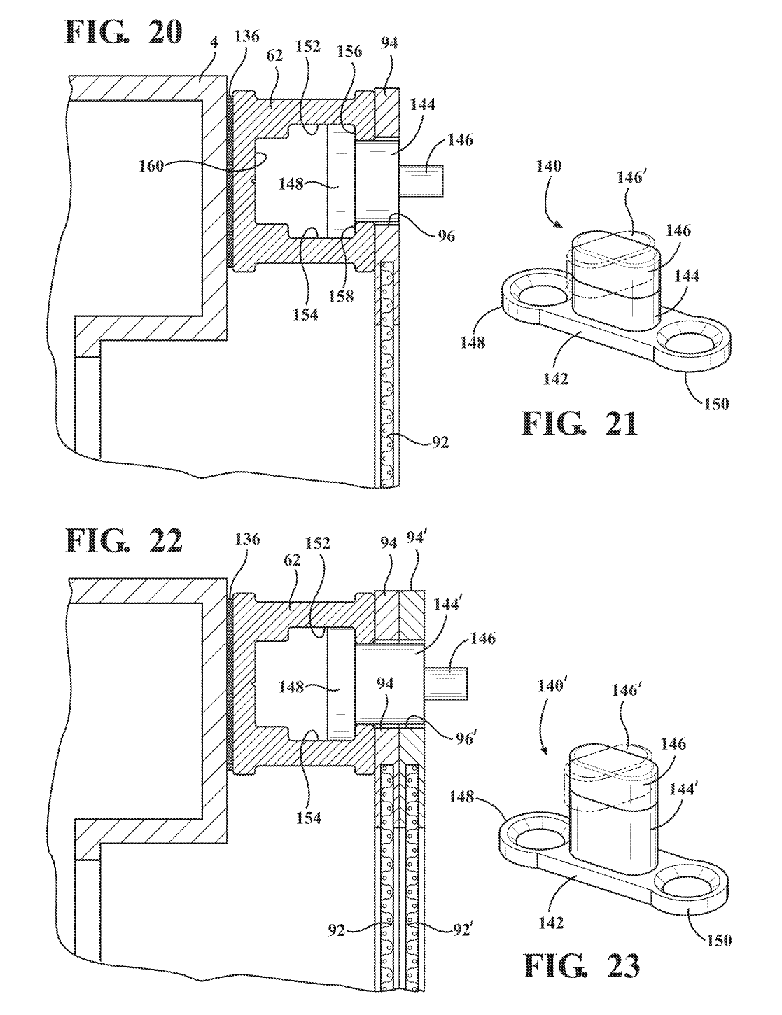

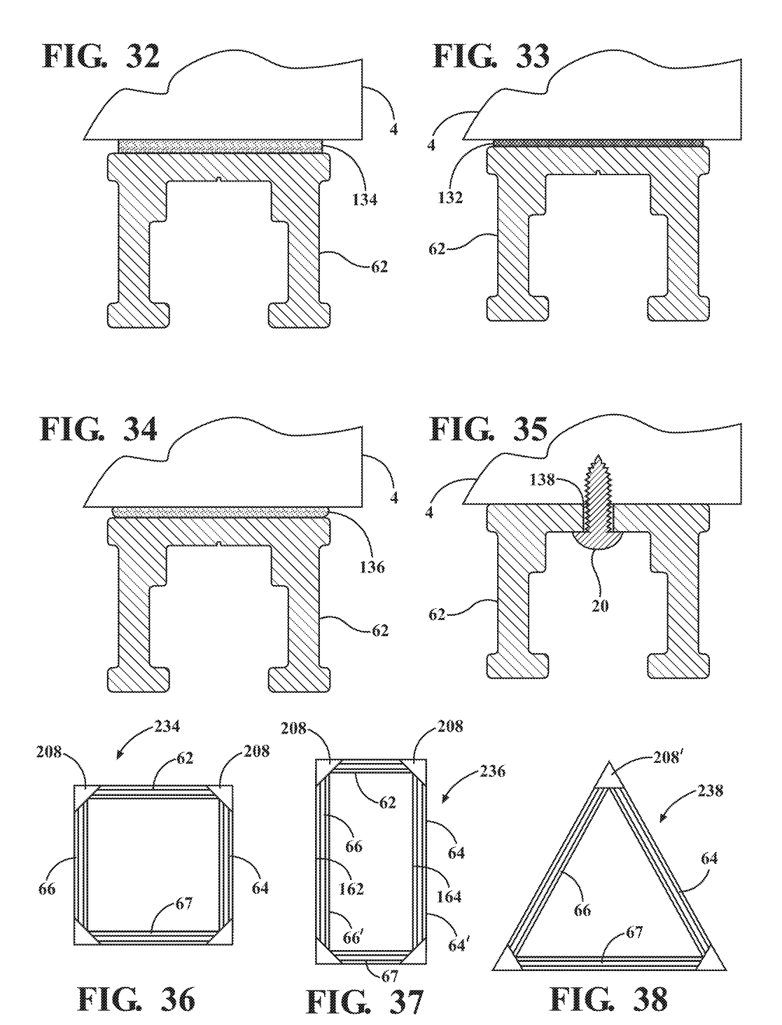

FIG. 20 is a cross sectional cutaway of a selected track support 62 from FIG. 19 and illustrating an underside positioned magnet 132 (see also FIG. 33) for assisting in releasably securing the support in extending fashion along a metal receiving surface of the intake face 4. Corresponding FIG. 32 is a cutaway plan illustration of selected track support 62 and depicting a two-sided adhesive tape 134 backing for securing the support to an intake face location.

FIG. 34 is a further plan illustration similar to FIGS. 32-33 of a glue 136 for attaching the track support 62 to the intake face location. FIG. 35 is a yet further plan illustration of a conventional screw, again at 20, passing through an aperture 138 in a base of the track support for mounting to the intake face location.

Proceeding to FIG. 21, an illustration is provided generally at 140 of a selected twist lock fastener utilized in the engagement protocol of FIG. 20. Similar to the twist lock variant previously disclosed, a generally planar base 142 is adapted to being received within the open end of the interior channel or track defined in the elongated support, a fixed body portion 144 extending from the base and concluding in an end support twist lock portion 146 (see further rotated position 146′ depicted in phantom). The base 142 further exhibits widened end support locations 148 and 150, these being dimensioned for facilitating frictional and positional fitting within the interior track defining sides, see at 152 and 154 of the support 62 in FIG. 20, concurrent with the upper edge surfaces of the base 142 abutting the forward inside edges 156 and 158 associated with the narrowed slot, a rear or back surface 160 interconnecting the sides 152 and 154 and completing the interior channel profile.

FIG. 22 is a cross sectional cutaway of a selected track support 62 as previously shown in FIG. 20 and illustrating a variant 140′ of the twist lock fastener exhibiting a lengthened fixed support portion 144′. FIG. 23 is an illustration of the modified twist lock fastener, similar to that shown in FIG. 21, and exhibiting the fastener 140′ installed in the track support 62 such that the lengthened fixed support portion 144′ is capable of accommodating any of thicker filter screens, multiple layer screens or materials (see as depicted at 92/92′ with dual layers of reinforced edges 94/94′ and aligning ringlet or grommet defined receiving apertures 92. As with the variant of fastener in FIG. 21, the widened base locations 148 and 150 facilitate frictional engagement along the interior side edges 152 and 154 of the supports.

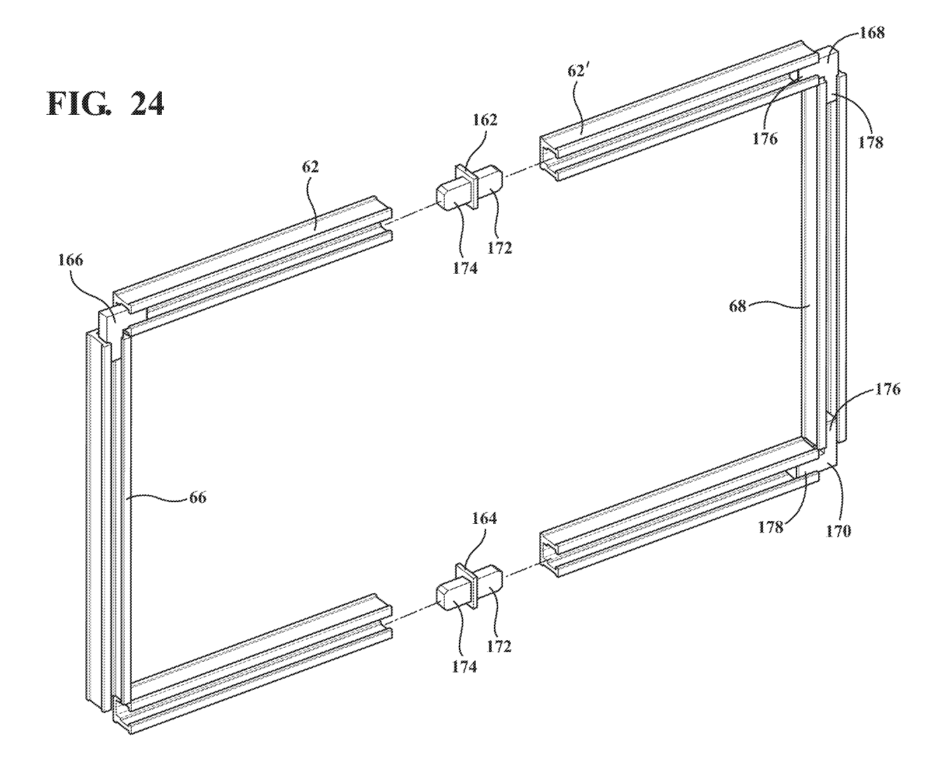

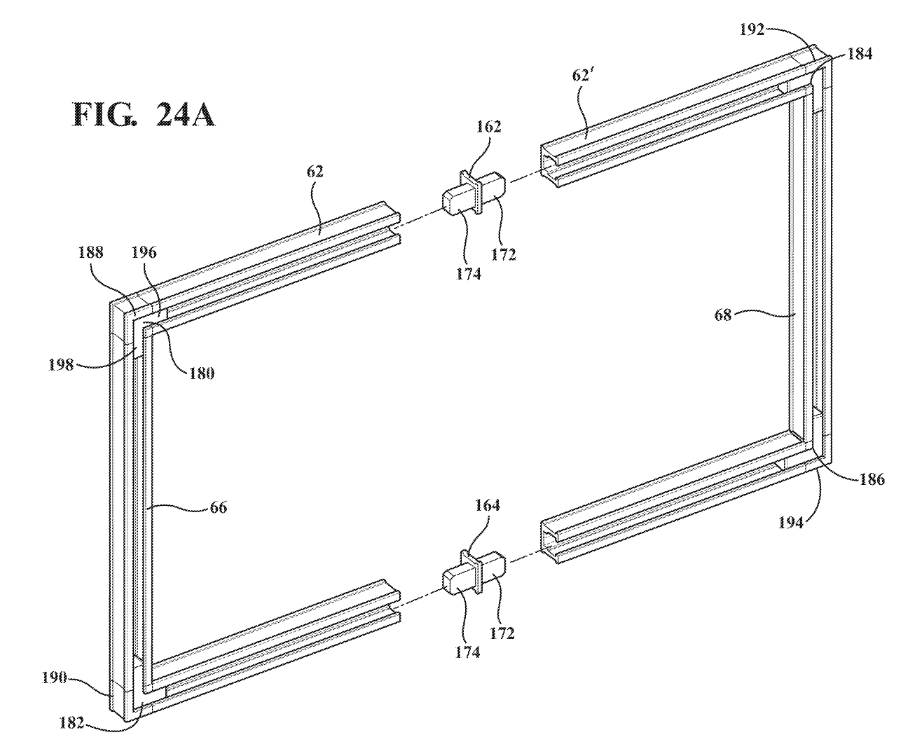

FIG. 24 is a partially exploded view of a support track arrangement according to a modification of FIG. 19 and which includes the provision of intermediate end-to-end 162 and 164 and corner/angled 166, 168, 170, et seq. adaptors or plugs for assembling running lengths of support track (see further at 62/62′, 66, 68, et seq.) in varying arrangements upon the air intake face. The intermediate adaptors 162 and 164, as shown, each exhibit a central support from which project a pair of opposite engaging portions 172/174 which are adapted to engage the interior defined channel ends of the supports. The corner/angled adaptors each further include a generally “L” shape with engaging portions 176 and 178 for joining angled ends of the support track, such as in the perpendicular arrangement shown.

FIG. 24A is a similar illustration to FIG. 24 and showing a variant of the corner adaptors/plugs, at 180, 182, 184, and 186 for providing the assembled support track as a rigid standalone frame with a seamless edge appearance. As further best shown in kit assembly view of FIG. 39, the modified corner plugs 180-186 each include an additional outer “L” shaped embossed portion, see at 188, 190, 192 and 194 corresponding to each plug 180-186. Upon the angled projecting portions (see further at 196 and 198 for selected plug 180) seating within the interior channels of associated angled supports 62/66, the outer embossed portions (188) of each corner plug seats against the ends surfaces of the channels to establish the seamless appearance shown.

FIGS. 24B-24C respectively illustrated exploded and assembled views of a further three sided variant of linear end-to-end adaptor, see at 191, which is configured to attached abutting opposing ends of first 62 and second 62′ selected running lengths of support track, these being shown in reduced length. As best shown in FIG. 24B, the three sided linear adapter 191 exhibits a generally reverse “C” shape in cross section and defines an inside configured profile (see interconnected surfaces 193, 195 and 197) which is adapted to slidingly receive and seat the opposing ends of the track 62/62′ in abutting fashion.

The adapter 191 can include any flexible material, such as a heavy duty nylon or plastic which has a high degree of resilience and, as further shown, is flexibly applied over the three projecting sides of the opposing mating ends of the track sections 62/62′, so that the end-most opposing track sections are thereafter frictionally gripped and restrained within the inner “C” defined surfaces 193, 195 and 197. Without limitation, the opposing ends of the tracks can be inserted within the adaptor 191 (as well as the adaptor variant depicted at 162/164 in FIG. 24), either prior or subsequent to mounting the track sections to the air intake face. In this fashion, the present inventions provide for a rigid stand-alone frame construction for supporting the screen or other covering.

As further understood, the construction of the connectors/plugs can include a compressible polymer or the like (such also potentially including a foam outer layering) which can frictionally seat within the irregular end profile of the supports and facilitates seating engagement between the linear end-to-end or angled supports and thereby provides for secure and seamless engagement between the interconnected sections of track support.

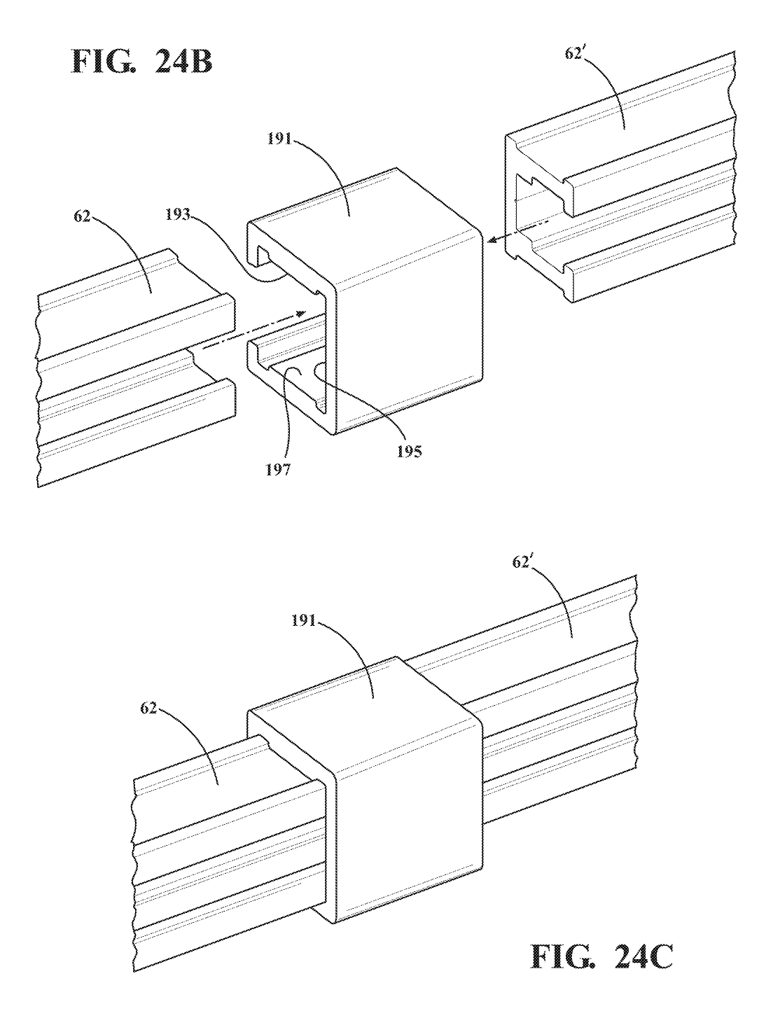

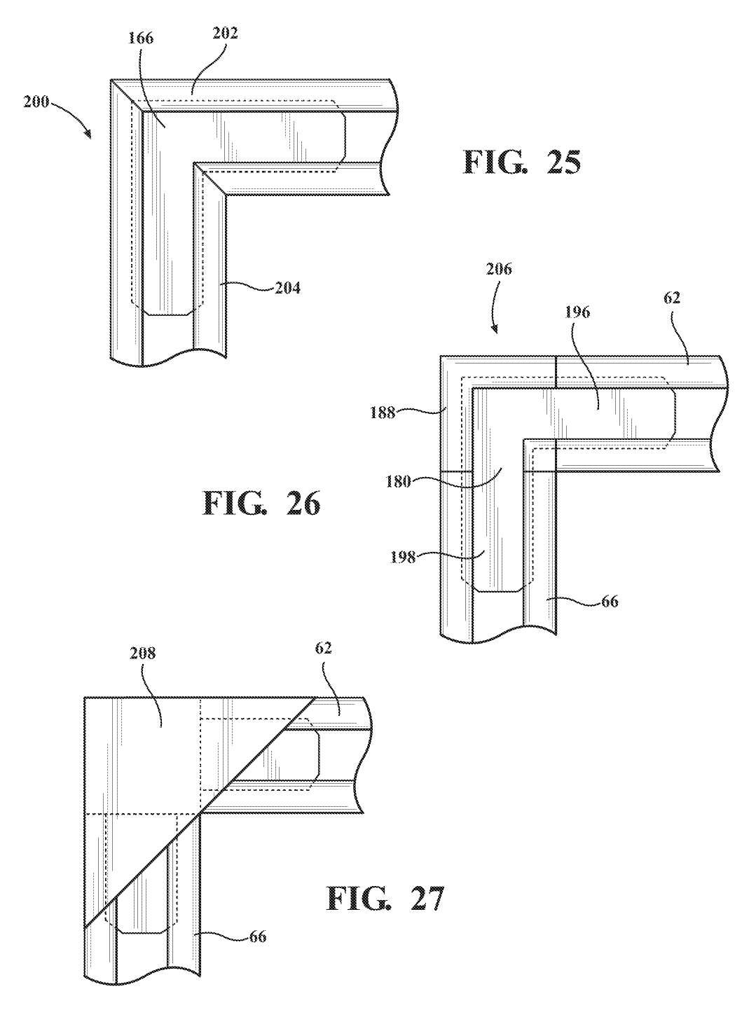

FIG. 25 is a partial corner depiction, generally at 200 of a further joining arrangement established between perpendicular arranged support track 202 and 204, such having a mitered appearance and within opposing ends of which the angled corner adaptor 166 is frictionally seated. FIG. 26 is a corresponding corner depiction, generally at 206, showing the modified corner adaptors of FIG. 24A. FIG. 27 is a further variant of a three dimensional triangular enclosure 208 utilized with any variant of corner plug/adaptor and for providing additional structural support between angled extending ends of support track 62 and 66;

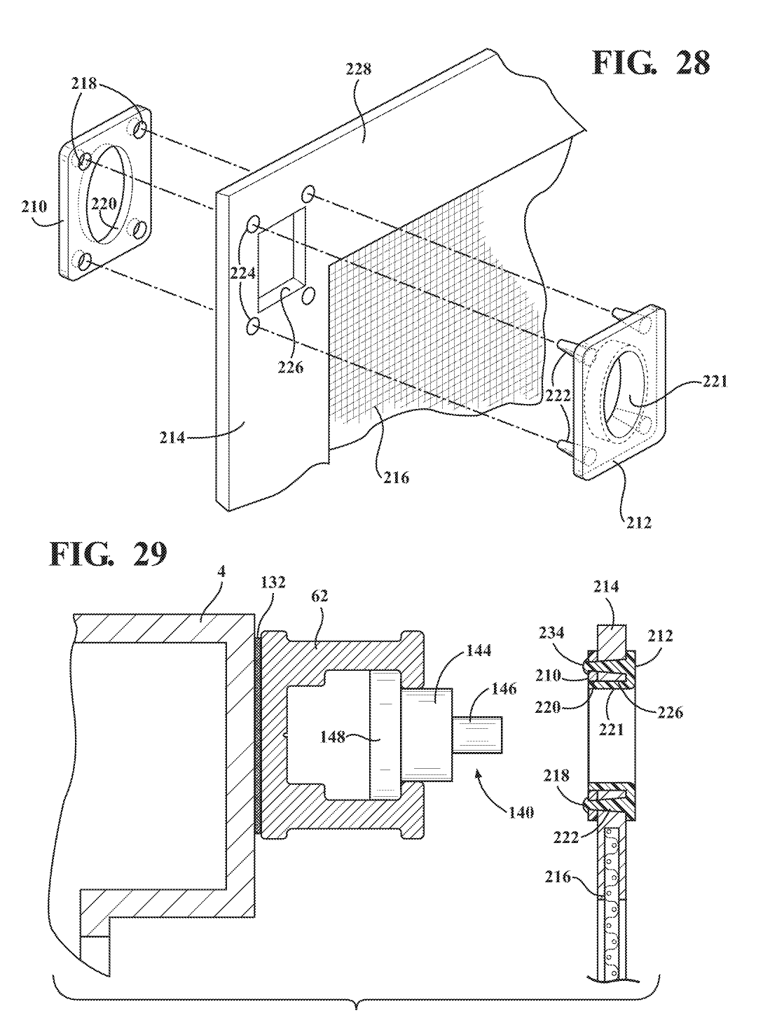

FIG. 28 is an illustration of a further variant of screen attached grommet in the form of a two-piece sandwich configuration 210 and 212 for inter-engaging through opposite sides of a reinforced corner location 214 of an associated screen 216. The grommets each include a planar disc shape with the first piece 210 having perimeter defined apertures 218 and a central receiving aperture 220. The second piece 212 likewise includes a plurality of prongs 222 projecting from a surface thereof (a central aperture 221 also defined in the piece 212) and which, upon piercing through the covering or screen 216 (see as depicted by aperture patterns 224, 226, et seq. defined in the reinforced edge 214) resistively engage and seat within the perimeter defined apertures 218 of the first piece 210 in order to mount both pieces together on opposite sides of the material with the inner apertures 220/221 in alignment.

The two piece grommet assembly can also be utilized with a knife edge such that, and upon mounting in sandwiching fashion about the screen (not previously apertured such as at 224/226), the knife edge can be utilized to cut out the screen portion revealed by the mating aperture defining inner perimeter surfaces 220/221, this in order to create the necessary interior aperture for receiving the selected fastener portion. FIG. 29 is a further partially exploded plan view of the assembled screen grommet of FIG. 28 in combination with the twist lock fastener (140) of FIGS. 21 and 23.

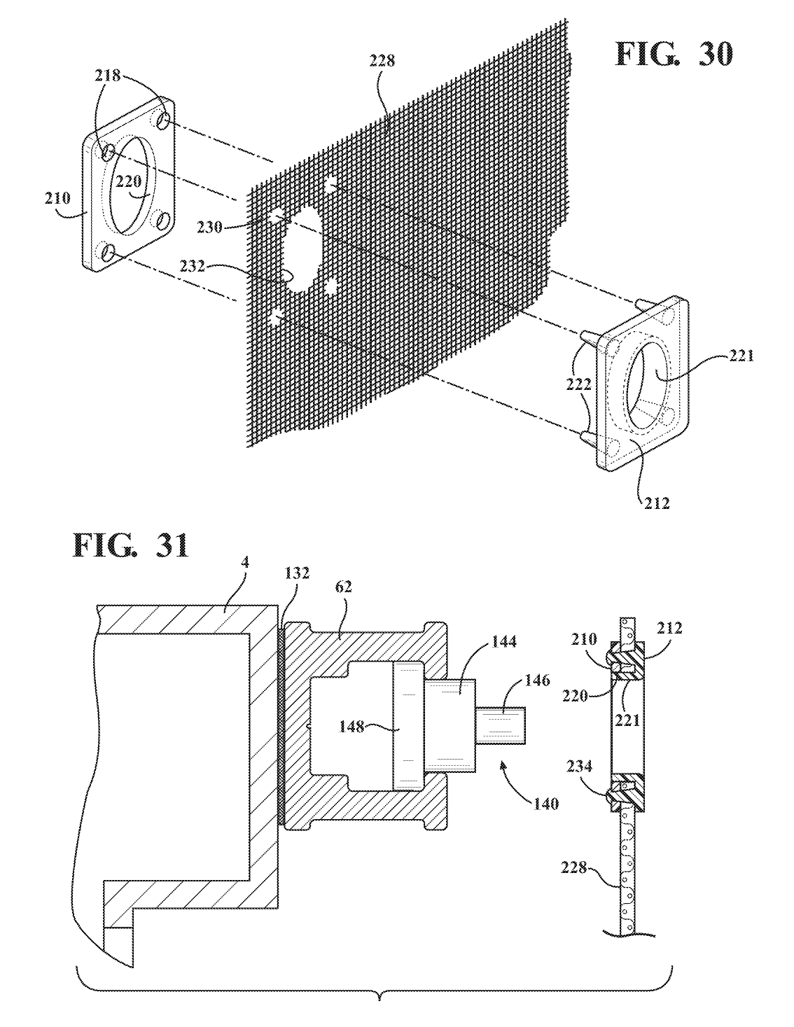

FIG. 30 is an illustration similar to FIG. 28 and depicting an unreinforced screen 228 utilized in combination with the two piece assembleable grommet 210/212. As with the embodiment of FIGS. 28-29, the two pieces are assembleable in a manner which sandwiches a perimeter location of the screen 228, such as which can exhibit pre-apertured locations 230, 232, et seq.

Alternately, the screen 228 can be provided in stock form without any pre-incisions, such as along the perimeter receiving locations for receiving the grommets. The screen 228 can be sized, on site, such as with the use of a knife edge. It is also envisioned that the variations of the prongs 222 can also include rounded end locations (see at 234 in cutaway in each of FIGS. 29 and 31) which are sufficiently deformable in order to pass through the interior profiles defined by the mating apertures 218 of the grommet piece 210, and subsequently engage the reverse (rear) surface locations of the piece 210 in order to maintain the sandwiched locations of the grommets pieces 210/212 with the screen therebetween. FIG. 31 is a further partially exploded plan view of the assembled screen grommet of FIG. 30 in combination with the twist lock fastener of FIGS. 21 and 23.

Proceeding to FIG. 36, a front plan illustration is generally shown at 234 of a square track support arrangement (see supports 62, 64, 66 and 67) in combination with the triangular three dimensional corner supports 208 of FIG. 27. The corner supports, as previously described, each include a triangular 3D construction and exhibit a hollow interior and can be concurrently fastened to the air intake surface for providing aligning and retaining support between opposing arrayed ends of track support, such further attached fixedly or removably in any fashion desired and which can further include any of end-to-end, mitred or other interconnecting arrangement.

FIG. 37 is a front plan view, similar to FIG. 36, of a rectangular support track arrangement 236, such as which can be assembled using the linear adapters 162/164, in combination with pairs 64/64′ and 66/66′ of elongated track supports in combination with upper 62 and lower 67 interconnecting supports. FIG. 38 is a further front plan view of a triangular support track arrangement 238 and which is shown with three supports 65, 66 and 67 along with a modification 208′ of the three dimensional corner supports. The triangular arrangement 238 is provided to support the proposition that the supports can be configured or arrayed in any perimeter extending fashion for covering any type of air intake opening.

FIG. 39 is a kit illustration depicting one non-limiting combination of items utilized in the method and assembly of constructing a screen, mesh or other covering supported upon the intake face over the air intake opening. As described, the kit and assembly can include a selected plurality of the support tracks, 62, 64, 66, 67, et seq., stock filter or other flexible mesh or non-mesh material 228, assembleable grommets 210/212, any type of fastener (represented by twist lock fasteners 140 of FIG. 21), and any combination of linear end-to-end 162/164 and angled/corner 180, 182, 184, et seq. interconnecting adaptors according to any one of a number of non-limiting variant of the present inventions.

As further shown, the supports 62, 64, 66 and 67 can include magnetic backings 132 (or alternatively any other permanent or removable mounting options as previously described not limited to adhesives, adhesive tape, fasteners, glue, etc.). Advantages of the present invention include the ability to both quickly install any desired covering material utilizing any of the fasteners previously disclosed, combined with the self-aligning aspects provided by the combination of channel rails and fasteners, this in order to accommodate variations in production tolerances of the filter as it translates to installation and alignment when installed. Additional variants further envision the utilization of any number of channel supporting rails typically ranging from one to four, with two, three or four such rails being the typical arrangements.

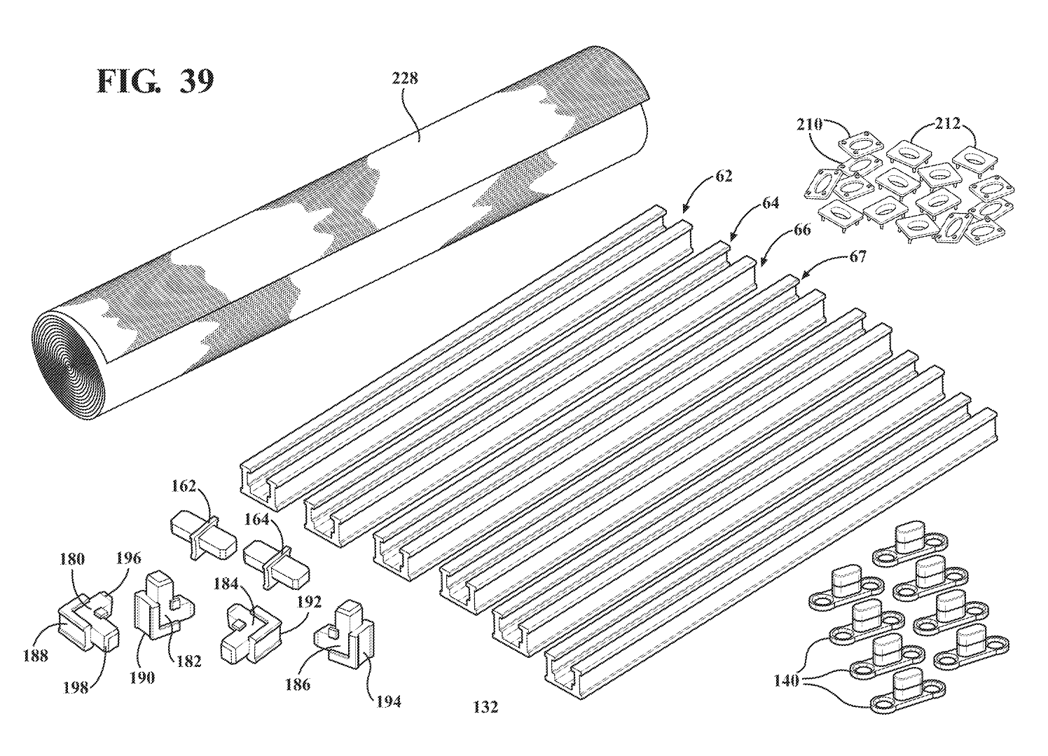

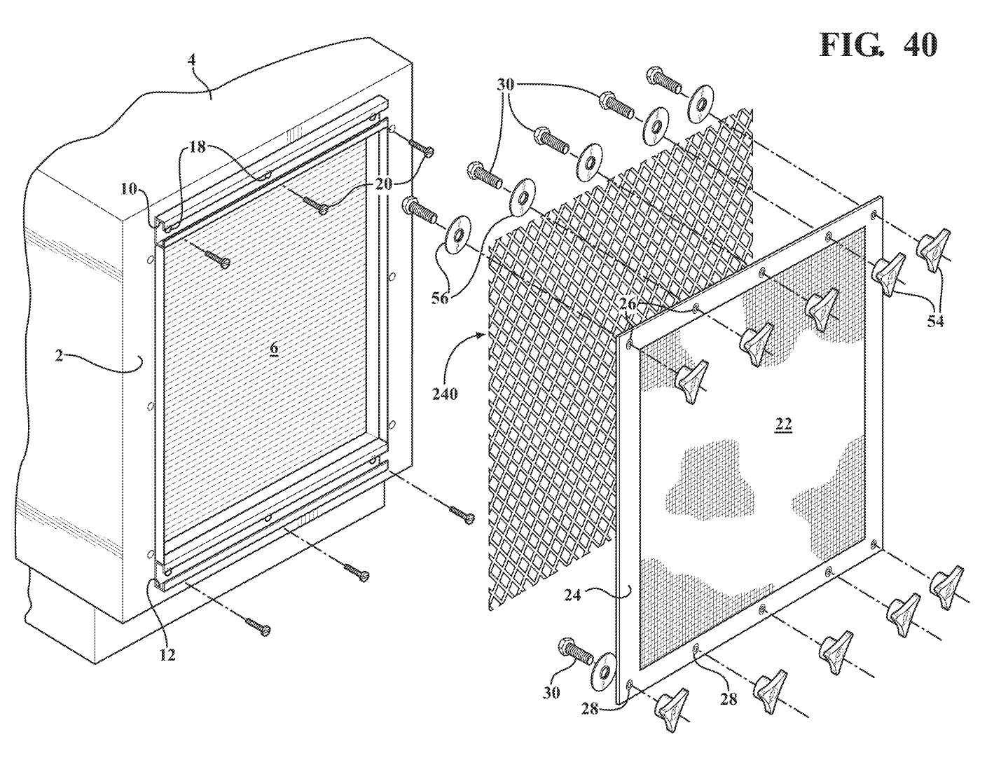

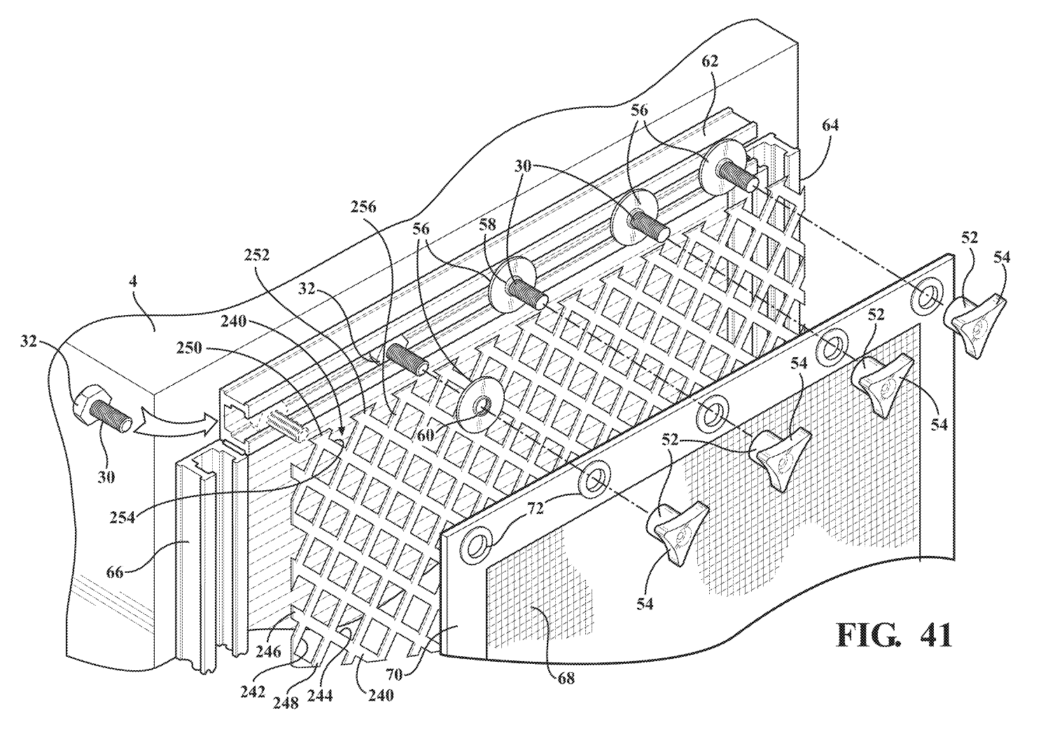

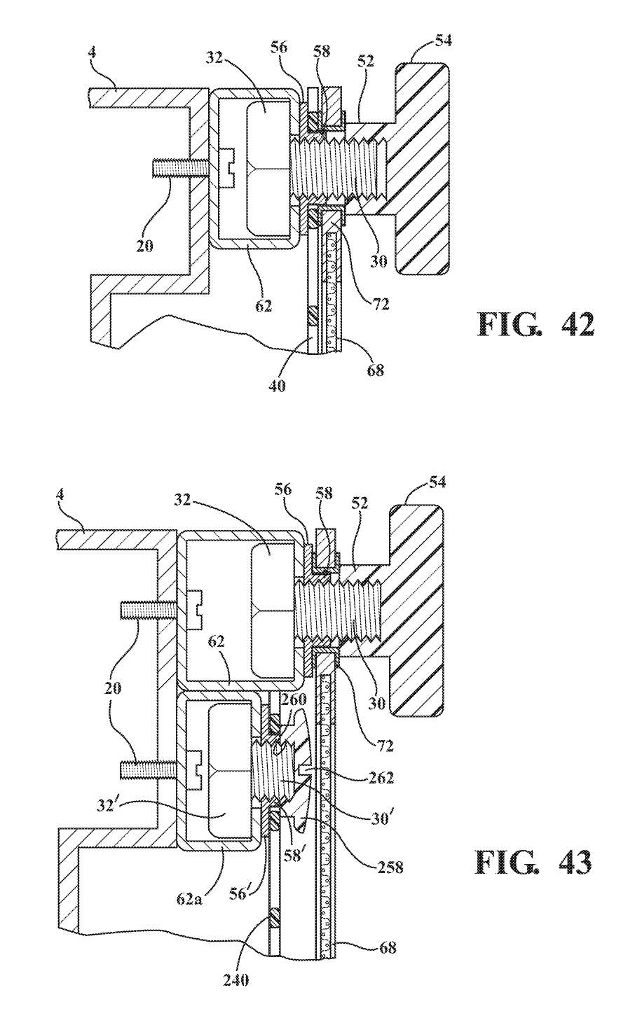

Referring now to the succession of views shown in FIGS. 40-42, a pair of exploded (FIGS. 40 and 41) and side cutaway/assembled (FIG. 42) views are shown of a lattice style mesh 240 provided in combination with the intake face mounted track mount kit (see again exemplary upper 10 and lower 12 extending track supports) and the overlaying screen (again as previously shown at 22 in non-limiting representation) according to a further non-limiting embodiment. A fastener configuration similar to that shown previously in FIGS. 6A and 6B is depicted and again includes an arrangement of twist caps 52 in use with the fasteners (threaded shafts 30 which are also termed “snug nuts” as well as an equal number of hex heads 32) of FIG. 5.

As previously noted, the twist knobs depict collars which are interiorly threaded from an open inner end (not shown) and further each include a triangular (or other suitable and polygonal) shaped gripping end 54. As additionally shown in FIG. 6B, an equal plurality of modified washers 56 are provided, each of these including a protuberant collar 58 defining an interiorly threaded profile 60. The bolts (hex head 32 and stem 30) are pre-installed into an open channel end defined in a modified support track (see at 62, 64 and 66 in FIG. 6 arranged about the intake opening of the associated structure 4) and so that the threaded stems 30 projecting through the front disposed slot in the manner depicted. As further previously described, the elongated track supports are similar in application to those previously disclosed at 10 and 12 in FIG. 1 and can include a slightly modified extrusion profile and, as will be further described, can be attached both to the face of intake structure and interconnected in end-to-end fashion according to a variety of different configurations.

The rigid mesh 240 in FIGS. 40-42 can include any semi-rigid or rigid apertured material including any of a metal, plastic coated metal, rigid nylon, fiberglass, and other molded materials, etc. and which, as shown in each of FIGS. 40-41, exhibits a generally rectangular outline which generally matches the dimensions of the multi-sided track mount kit. The mesh 240 can also include either of a completely or substantially rigid material (e.g. providing any degree of minor bend or flex) as needed to facilitate securing upon the track mount kit.

The rigid mesh 240 further exhibits an aperture pattern to permit the projecting bolt fasteners, or other projecting engagement portion associated with any other configuration of fastener, to extend from the track and so as to project beyond any of interior or edge proximate locations of the mesh for receiving the aperture edge proximate locations of the filter or other suitable covering. As further shown, this can include the rigid mesh 240 exhibiting diamond shaped or other apertures (see inner perimeter surfaces at 242, 244, et seq. in FIG. 41) which establish the four sided diamond shaped apertures and which are further defined by cross-wise extending and interconnecting portions 246, 248, et seq. further defining the physical construction of the rigid mesh.

The rigid mesh additionally depicts enlarged end defined locations 250, 252, et seq. which can combine with open communicating and edge proximate diamond aperture profiles (see at 254, 256, et seq.) in order to seat the projecting bolt stems 30 in edge engaging fashion about the outer perimeter of the mesh 240. Alternatively, the rigid mesh 240 can be sized so that the bolt stems seat through interior located diamond (or other shaped) apertures 242, 244, et seq. which are located proximate the extending edges of the mesh.

As previously described, FIG. 41 is an enlarged partial perspective of the variant of FIG. 40 and further illustrating the rigid lattice style mesh in a partially assembled condition overlaying the projecting threaded shafts of the associated bolt fasteners pre-positioned within the extending tracks mounted to the intake face. FIG. 42 is a side cutaway illustration of a fully assembled rigid mesh and overlaid screen relative to the air intake face and engaging fasteners.

In use according to one non-limiting variant, the rigid mesh 240 is provided and is positioned between the filter 22 and the track defining supports (kit) in order to provide additional protection to the intake face and surrounding opening, prevents the filter from being sucked into the intake opening as well as protecting the underlying mechanical components, i.e. condenser coils, the overlaid filter, such as to protect against tearing in response to the striking of objects during windy conditions and the like such as hail and other airborne objects. As further described, the configuration of flexible outer screen 22 with edge engaging apertures 26, along with the selected arrangement of fasteners shown is but one possible example of many which can be utilized with the rigid mesh 240 (such further contemplating the rigid mesh being used as a stand-alone installation as further described in FIG. 45). The variants of FIGS. 40-45 also contemplate the use of any other type of fastener, including both shown in the other illustrations as well as other non-illustrated fasteners which may be contemplated within the overall scope of the disclosure.

Proceeding to FIG. 43, a further side cutaway is shown of a variant of FIG. 42, and in which a second inwardly positioned support track 62a is secured to the intake face 4 relative to the outer track 62. As further shown, the inner track 62a may include reduced dimensions relative to the outer track 62, such that an end face of the track 62a is recessed relative to the channel mounting interface of the outer track 62.

The inner track 62a separately mounts the rigid mesh 240, with the use of reduced dimension bolt fastener (shaft or extending portion 30′ and first inserting portion or head 32′) which is supported within the track interior of the support 62a. A number of modified washer 56 are again provided, each of these including a protuberant collar 58 defining an interiorly threaded profile 60.

As described in the construction of FIG. 42, the bolts (hex head 32′ and stem 30′) are pre-installed into an open channel end defined in a modified support track (in this instance at 62a but which is understood to include the use of any interconnecting arrangement of inwardly supported support tracks which can correspond in overall outline to those previously illustrated at 62, 64 and 66 in FIG. 6 arranged about the intake opening of the associated structure 4) and so that the threaded stems 30′ of the inwardly supported support tracks projecting through the front disposed slot in the manner depicted. A cap (also end attachable covering portion) 258, further such as a metal or heavy duty plastic/nylon, includes a designated dimension and thickness with an inner recess profile 260 for rotatably interengaging the threads 30′ of the modified bolt fastener. A screw driver slot 262 is also shown for installing the cap 258 in order compress the rigid mesh 240 against the slot defined end surfaces of the inner support tracks 62a and supported modified washers 58. The non-limiting example of screen 68 is mounted to the outer support tracks 62, 64, 66, et seq. in the manner previously described and as shown in FIG. 42.

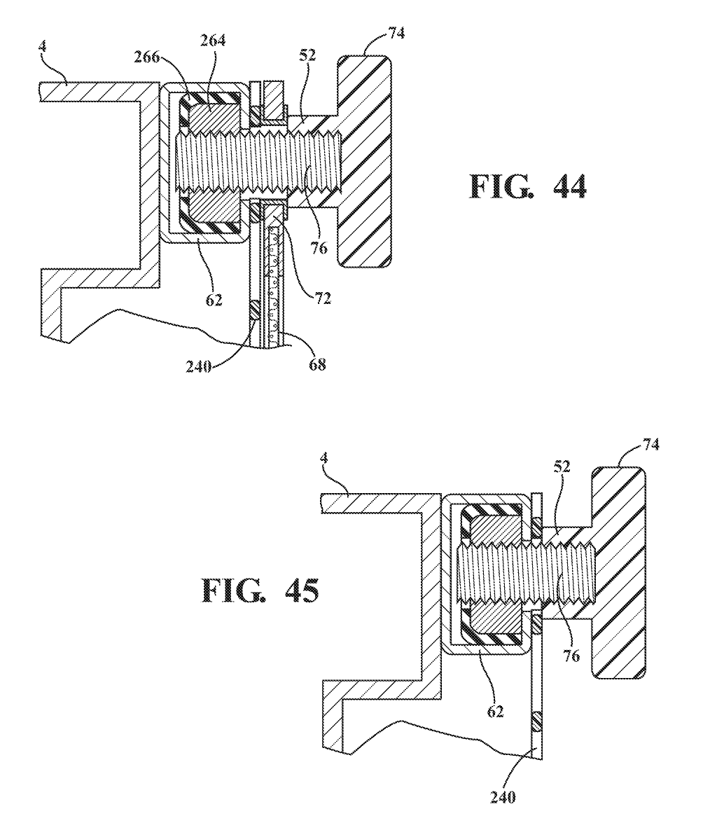

FIG. 44 is a further side cutaway of a variant similar to FIG. 42 and illustrating a different fastener arrangement again including a reconfigured twist knob 74 such as previously shown in FIG. 6C, and which is modified so that the threaded projecting stem 76 is mounted to the inside of the knob 74. A reconfigured and interiorly threaded nut 264 is provided (can also be termed a first fastener portion), having an outer rubberized and gripping coating 266, and which is inserted through the open end of the support track.

Similar to the mounting arrangements previously described, one non-limiting installation procedure can include partially engaging the twist knob 74 with extending shaft (or extending portion) 76 to the nut (first fastener portion) 264, then translating the nut from the open installation end of the support track 62 to the desired installation location, following which the knob (or covering cap) 74 is removed and the mesh 240 and screen 68 positioned in place, prior to the extending stem 76 of the knob being reinserted through the screen, mesh and back into threaded rotational engagement with the nut 264. The outer rubberized coating 266 applied around the nut is further dimensioned such that it provides an intermediate friction fit with the inside walls of the track interior and, in this manner, prevents inadvertent sliding of the nut 264 during installation.

FIG. 45 is a modification of the variant of FIG. 44 to the extent only that it depicts a further mounting arrangement utilizing only the rigid mesh component 240 mounted to any arrangement or configuration of the support tracks 62, 64, 66, et. seq. and which would not require the outer screen 68 (or other flexible pervious or impervious covering). The present invention contemplates any of a number of mounting arrangements utilizing the rigid mesh alone (such as for use as a hail guard protector) or in use in combination with any type of pervious or impervious screen, filter or other outer covering to provide winterization of the desired mechanical equipment, again including but not limited to those including condenser coils.

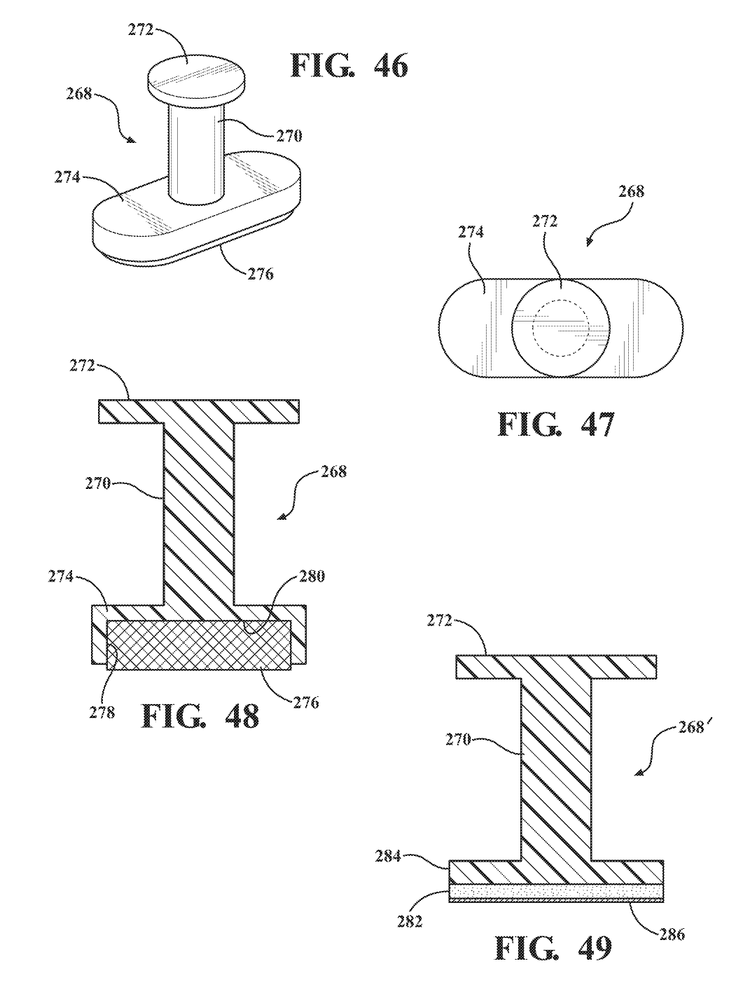

Referring now to FIGS. 46-47, respectively illustrated are perspective and top plan views of a fastener according to a further preferred embodiment, generally at 268, and which is adapted to being directly mounted to an air intake face or surface (see again at 2 in FIG. 40 of the air handling unit or equipment 4) in a further application of the present invention. For purposes of the present description, the use of the fasteners of FIGS. 46-71 secured directly against the intake face substitutes for the use of the channels 62, 64, 66, et seq. as shown in the preceding figures.

As will be further described, the variants of fasteners depicted throughout FIGS. 46-71 can be releasably attached to the intake face by such as rare earth or other heavy duty magnets. Additional variants include substituting the magnets with a heavy duty adhesive material, such further including a double-sided tape in which an adhesive is coated onto both sides of a carrier material. The tape is then wound with a release liner, commonly paper that has been coated on both sides with a silicone release agent. The carrier is typically a polymeric film, foam, paper, cloth or foil, coated with an acrylic, rubber or silicone adhesive. The adhesive can be the same on both sides or each side of the carrier can have different adhesive and coating thicknesses, such further referred to as a differential adhesive tape.

In the case of utilizing either magnets or adhesives, it is further understood from the relevant technical art that each individual fastener can withstand a permanent loading weight or force of 10-15 lbs. apiece, once secured to the intake face. With an expected plurality of a dozen or more of such fasteners secured to perimeter arrayed locations around the intake opening, the collective retaining force provided by the magnet or adhesive backed fasteners is determined to be more than adequate for providing durable and long-term retention of any single or multi-layered covering application, such including any combination of a flexible filter mesh, again at 22, an impermeable winter storage cover (not shown) and/or a rigid lattice work mesh 240 (as previously shown being further depicted by an interiorly aperture planar member which can mount directly to the projecting stem portions of each fastener).

Returning to the fastener 268 of FIG. 46, a partially to fully rigid retention post 270 is depicted in combination with an enlarged and deflectable retention head 272 (this also termed an “engaging portion” extending from the post and which is interpreted to include any twist lock, toggle lock or deflectable/compressible head portion associated with any of the embodiments depicted in FIGS. 46-71 as described herein). A pedestal base 274, such as which is depicted having an elongated and three dimensional shape, supports the rigid retention post 270 at a lower end.

FIG. 48 is a plan cutaway of the fastener of FIG. 46 and illustrating a magnet 276 (such again including any type of rare earth magnetic or the like which creates a strong adhering force when contacted with carbon steel surface of the air intake face 2). As further shown, the magnet 276 has a disk shape and can be integrated into an underside of a supporting base of the fastener, such as which can include an underside cavity (see interior cavity defining side and inner end profile surfaces 278 and 280) for receiving the magnet 276.

FIG. 49 is an alternate plan cutaway to FIG. 48 and illustrating a durable adhesive layer 282 integrated into an underside of a refashioned fastener base 284, such as which includes silicone and adhesive admixtures not limited to those described above and further including a surface peel-away layer 286 to assist in mounting the fastener (at 268′) to the intake face. For purposes of the present description, any of the fastener designs disclosed can be modified for use with either of magnets or adhesives and it is further envisioned that these can be provided as separate attachable portions in variations of installation kits in which a given fastener base can be configured for using either a magnet or adhesive depending upon the given installation environment.

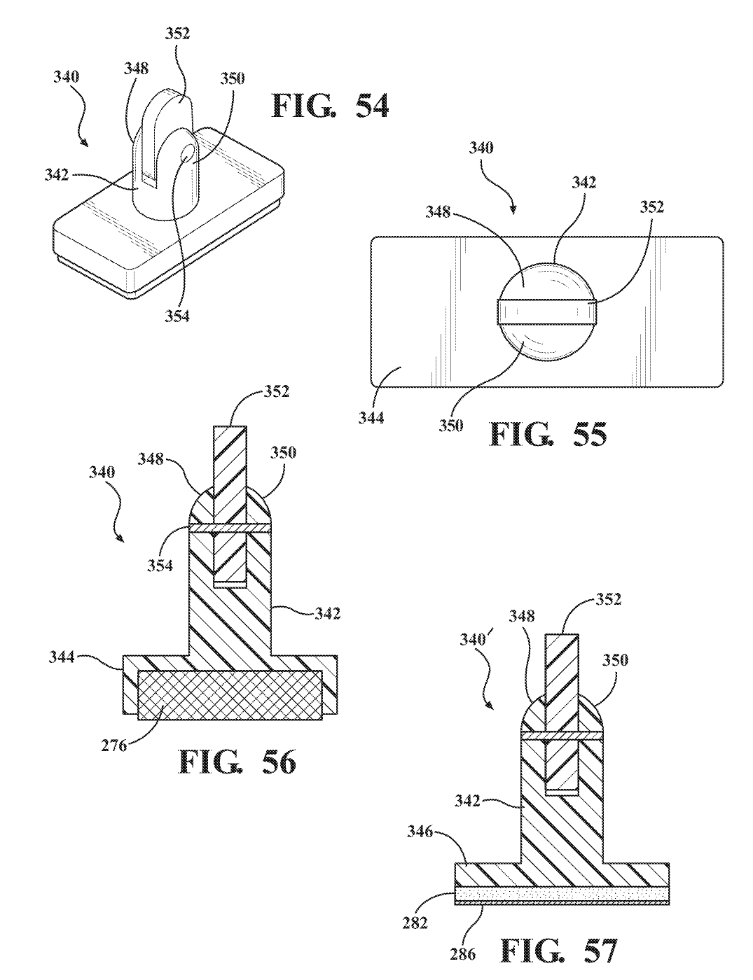

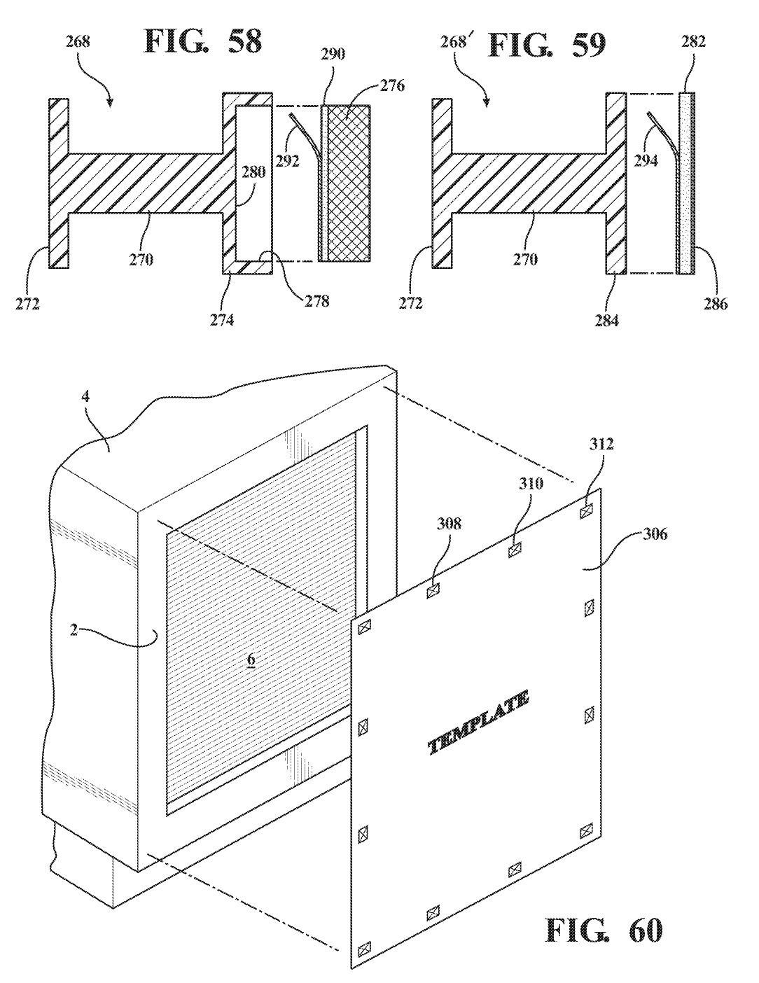

This is further evident in FIGS. 58 and 59 which illustrate a pair of cutaway plan views which, consistent to those previously shown in FIGS. 48-49, depict a further kit variation of the present invention in which either of magnet 276 or adhesive mounting components 282 can be provided separately for engagement to the underside of the fastener. As understood the magnet 276 or adhesive 282 variants of the fasteners 268/268′ can be originally produced secured to the fastener (with the adhesive variant exhibiting a single exposed peel away layer 286).

Alternatively, the magnets or adhesives can be separately provided to the installer, who can then assemble the same to the base (274 or 284) of the specific type of fastener (268 or 268′). This can include providing an upper surface adhesive 290 to the magnet 276 (similar to the types previously described) along with a peel away surface tape 292 for pre-mounting the magnet into the fastener cavity underside (FIG. 58).

As is further the case in FIG. 59, a second upper surface peel away strip 294 is provided for pre-securing the adhesive 282 to the underside of the base 284 of the fastener reconfiguration 268′ and prior to final installation. Alternatively, the individual adhesive portions 282 can be initially applied directly to the air intake face 2 surrounding the opening 6 (see FIG. 60 and such as upon first removing the selected tape layer 286), this prior to attachment of the exposed adhesive side (upon removing the second peel away tape strip 294). The present invention contemplates either protocol in assembling the kit with the adhesives either initially to the intake surface or to the underside base of any version of fastener as described or suggested herein. Likewise, the magnets 276 can likewise be pre-attached to the surface of the intake face in a related installation application and the release tape layer 292 removed for engaging to the fastener 268.

The material construction of the fastener 268 again contemplates a rigid base and post (or stem), with the upper enlarged head 272 including any similar semi-rigid or partially deflectable/bendable material for seating through the ring or grommet defined aperture in the filter, screen or other covering of non-limited variety. Without limitation, the enlarged head 272 can be provided of a similar or different thermoplastic material as compared to the rigid post 270 and mounting base 274 of the fastener (such as which can be formed during a dual state injection molding or other forming process).

A non-exclusive listing of polymeric based materials employed in the fastener construction and manufacture can include such as a durable polypropylene (PP), Polyethylene terephthalate (PET or PETE), High-density polyethylene (HDPE). Polyvinyl chloride (PVC),

Low-density polyethylene (LDPE), or other material which provide necessary controlled collapse and re-expansion during installation through for resistively seating through and subsequently over the ring or grommet configured into the filter cover. To the extent that the enlarged and deflectable/flex head portion of the fastener may differ in material construction or properties from the post and base, it may also envision the addition of an additional rubberized or flex ingredient to assist in establishing the desired properties for flexing and holding in place once installed through the filter/cover edge extending grommet.

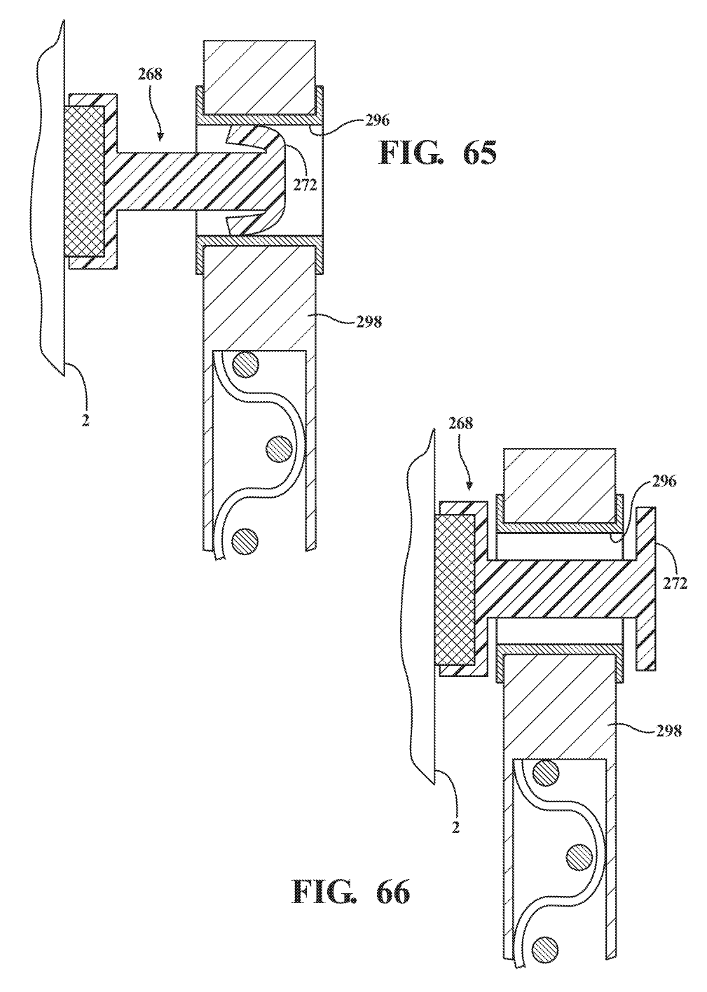

FIGS. 65-66 illustrates a pair of plan cutaway environmental views of the fastener 268 of FIG. 46, in each of an intermediate deflecting collapse/inserting position of the enlarge head 272 (FIG. 65) and subsequent pass through return expanded position (FIG. 66) for seating through an aperture defining grommet or ring, shown at 296 configured at a perimeter location of the attachable screen or covering, which is further represented at 298 and which is again understood to include any permeable, impermeable, flexible or rigid covering either provide individually or in multiple layers. In this manner, the heavy duty thermoplastic fastener 268 or 268′, such as which can further include a rubberized component or ingredient integrated into the flex top 272, provides the necessary flex and return properties to adequately hold and retain against the outer aperture rim surface of the ring or grommet 296 as depicted in FIG. 66.

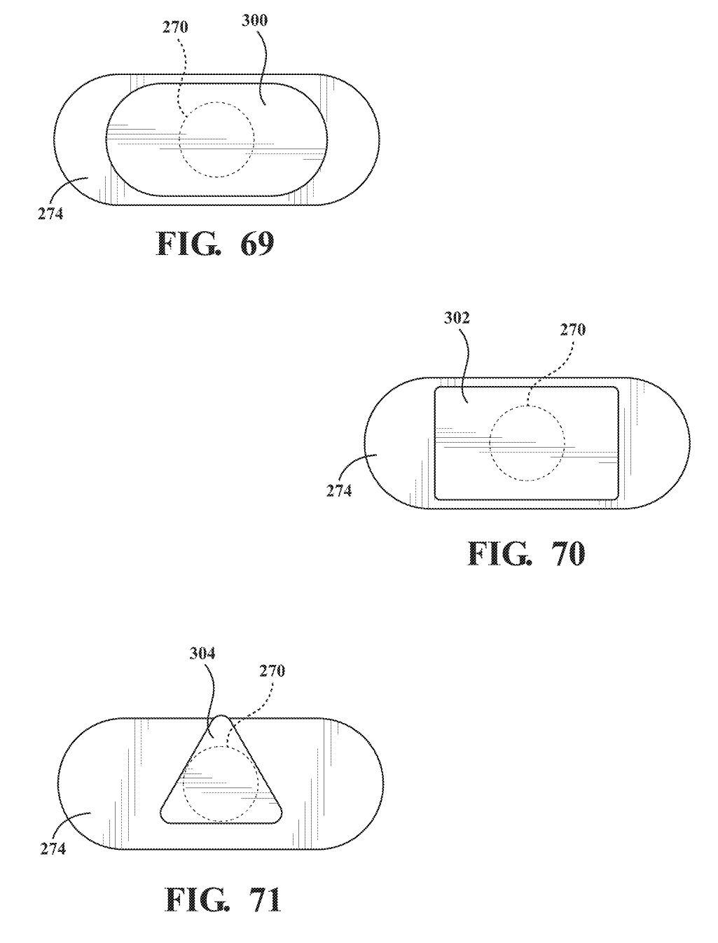

FIGS. 69-71 illustrate a series of top plan views of three further non-limiting examples of modified ellipsoidal (at 300), rectangular (at 302) and triangular (at 304) collapsible heads integrated into fasteners consistent with those depicted in FIGS. 46-49. These variations, in comparison to the disk or circular shaped enlarged deflectable head portion 272 of FIGS. 46-49, are intended to depict a non-exhaustive listing of variations of shapes which can be accorded the enlarged rubberized flex and return material construction of the enlarged head of the fastener during installation through and over the screen or covering grommet 296 of FIGS. 65-66.

As further shown in FIG. 60, a template sheet 306 (such including any paper or Mylar ply material) can be provided according to a further variant of the present invention, such including perimeter markings 308, 310, 312, et seq., which replicate both the cover dimensions and that of the associated grommet pattern associated with the covering and which can be used to mark locations for attaching the fasteners according to any of the present embodiments. It is envisioned that the template sheet 306 can be provided as part of a kit including the fasteners, magnet/adhesive attachments, and screen or covering, with the template providing a dimensional match to the cover and outer perimeter grommet pattern to allow for quick placement of the template sheet against the intake face 2 and over the opening 6, whereupon the installer can mark the perimeter locations for subsequent fast attachment of the fasteners. Although not shown, it is understood that the outermost perimeter band extending along the inside face or surface of the template (hidden from view in FIG. 60) can further exhibit a tacky surface material to provide temporary location of the template during marking of the fastener attachment locations.

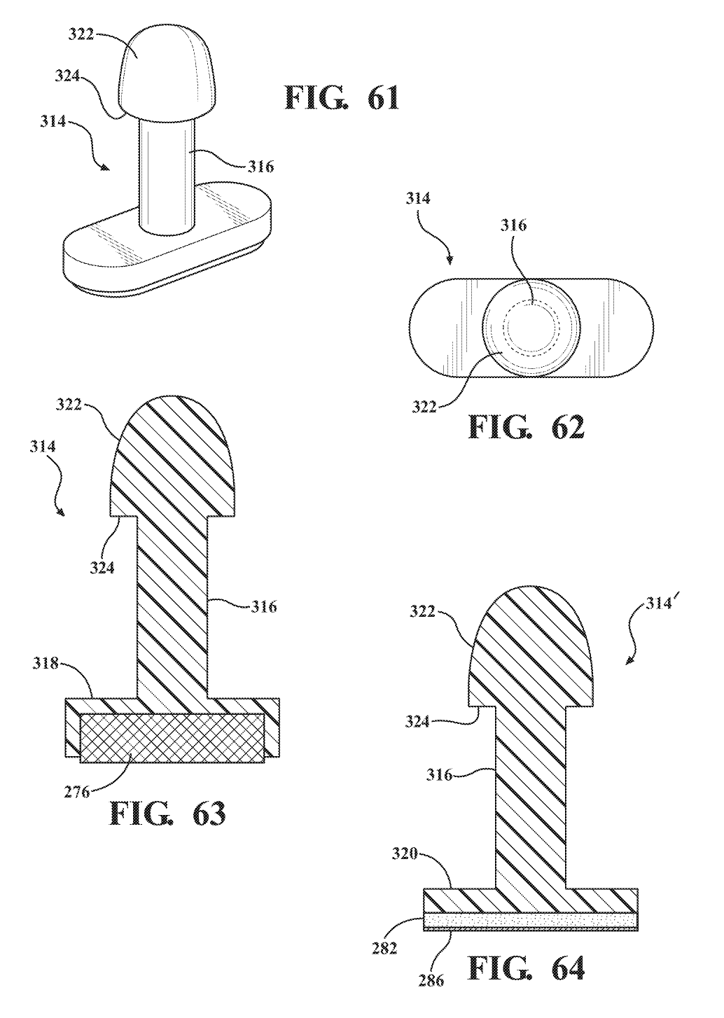

FIGS. 61-62 respectively illustrate perspective and top plan views of a fastener, generally at 314 according to a further preferred embodiment which is adapted to being directly mounted to an air intake face surface 2 in a yet further application of the present invention. The fastener 314, in comparison to that shown in FIG. 46, similarly presents a partially to fully rigid retention post 316 extending from a base either reconfigured (as shown at 318 in FIG. 63 and at 320 in FIG. 64) for incorporating either of a magnet 276 or an adhesive attachment 282 as previously described.

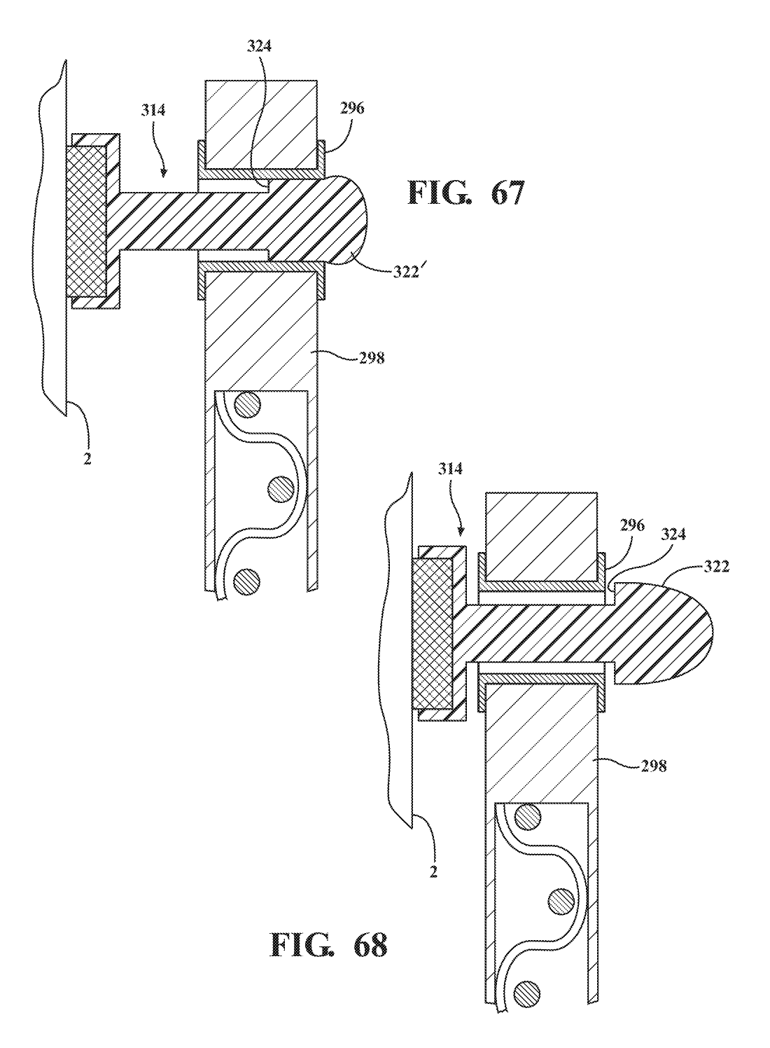

The pedestal mounting base components of each fastener type 314 and 314′ further generally mimics that depicted at 268 and 268′ for related variants of FIGS. 48 and 49, with the magnetic receiving fastener of FIG. 63 including a similar interior defined cavity (see also FIG. 48) and the adhesive underside supporting surface of the fastener of FIG. 64 likewise matching that shown in FIG. 49. The fasteners 314/314′ of FIGS. 61-64 further each include an enlarged and controlled collapsible/re-expandable retention head, see at 322, for resistively seating through and subsequently re-expanding over the ring or grommet (see again at 296 in FIG. 67-68) configured into the filter cover or other flexible or rigid covering 298.

The head 322 as further shown exhibits a generally three dimensional bulbous shape with an underside rim 324 communicating with the upper end of the rigid retention post 316. The material construction of the enlarged bulbous head 322 may, similar to the upper circular disk shaped enlarged portion 272 in the variant 268 of FIG. 46, include any sponge-like or flexible construction (such optionally including a rubberized component) and which permits the head to partially collapse (see at 322′ in FIG. 67) prior to re-expanding (FIG. 68) after passing fully through the grommet 296 and so that the underside rim 324 is abutted against the exterior rim of the grommet.

The bulbous head 322 can also be reconfigured to adapt to other shapes or profiles in order to provide different retention profiles in installation through the covering grommets. This can also include reconfiguring to include, without limitation, any type of mushroom, beam or other expandable configuration which can be squeezed or compressed during installation through the grommet interior, following which the expandable upper portion reseats over the rim exterior of the grommet for holding the covering in place.

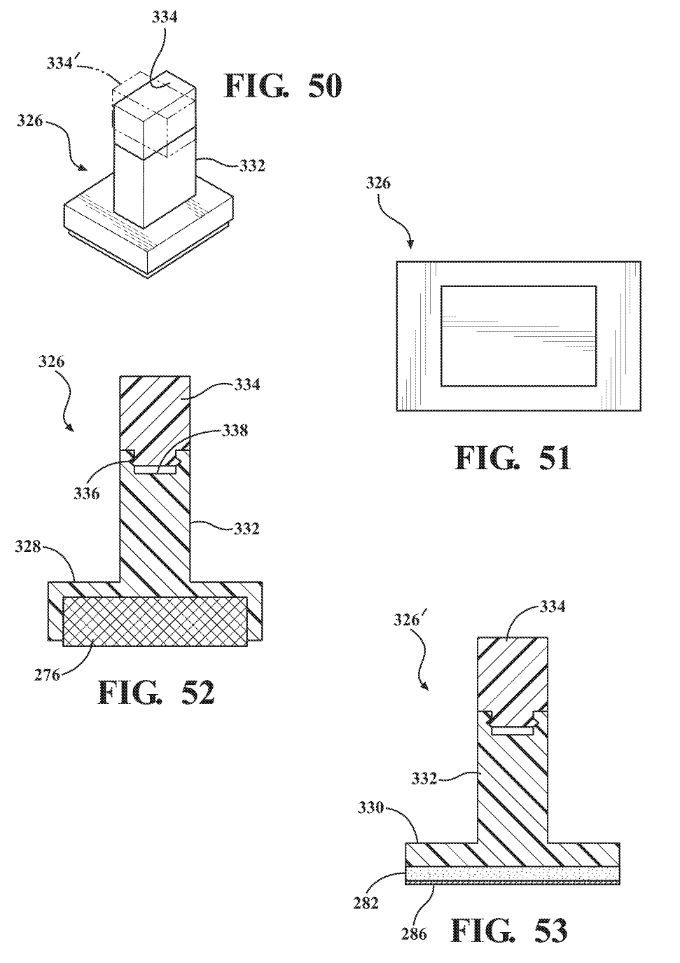

Proceeding on to FIGS. 50-51, respectively illustrated are perspective and top plan views of another type of twist lock fastener, generally at 326, for inserting through and subsequently retaining over and against the ring or grommet configured into the filter cover. Similar to the fastener designs of FIGS. 46 and 61, the twist lock fastener 326 can be configured with a base 328 (see cutaway of FIG. 52) or base 330 (see cutaway of FIG. 53) associated with either of a magnet 276 of adhesive 282 supporting variant (further at 326′ in FIG. 53).

The twist lock fastener 326 further includes a rigid overall construction which can include either of a durable plastic or metallic composition (unlike the collapsible/re-expandable fasteners of FIGS. 46 and 61 which necessitate the upper expanded or head portion again including a compressible and return expandable material). A lower pedestal fixed portion 332 is integrated into the base 330 (can be a single piece). An upper rotatable knob portion 334 is secured atop the lower fixed portion 332 so that it can be rotated 90° (see also position 334′) for insertion through a rectangular grommet window construction (see at 96 in screen 92 depicted in FIGS. 7 and 8A). The twist lock fastener 326 otherwise generally replicates the previous variant depicted at 88 and includes a suitable bias construction between the underside attachment location of the upper rotatable knob 334 (see enlarged rim location 336 in FIG. 52 cutaway which seats within receiving interior 338 defined in an upper interior location of the lower post 332, this enabling the upper knob 334 to twisted into engagement with the underside rim of the rectangular seating window after being pre-seated there through.

Finally, FIGS. 54-55 respectively illustrate perspective and top plan views of a toggle lock fastener, generally at 340, according to a further preferred embodiment which is likewise adapted to being directly mounted to an air intake face surface in a further application of the present invention. The toggle lock fastener 340 is similar to that shown at 100 in FIGS. 10-10B and includes a variation of a rigid post 342 which can be integrally formed with a cavity underside defining pedestal base 344, such again including an interior cavity for receiving the magnet 276 (see FIG. 56 plan cutaway).

An alternate version of the toggle lock fastener 340′ (see FIG. 57 plan cutaway) illustrates the durable adhesive layer 282 integrated into a refashioned planar underside of a fastener base 346, such as is similarly shown in each of the alternating fastener configurations in each of FIGS. 49, 57, 64 and including the surface peel-away layer 286 to assist in mounting to the intake face. As with the previous toggle fasteners 100 of FIG. 10 which slidably mount within the air intake face, the rigid post 342 likewise exhibits pseudo-cylindrical shaped which extends from the pedestal base.

The rigid post 342 is solid proximate its integral mounting location with the pedestal base and includes a pair of extending ears or lobes 348 and 350, these in turn establishing an inner slot or channel having a desired profile for seating therebetween a generally planar, curved edged and rotatable toggle element 352 mounted for rotation between the ears or lobes via a horizontal pin 354 (see FIGS. 54 and 56) extending through aligning apertures established in each of the lobes and the toggle element. In this fashion, and upon mounting the fasteners to the intake face and inserting through the grommets of the screen or covering, the toggle elements are each rotated 90° from the position depicted in FIG. 54 (with the interior toggle structure causing the elements to be fixed or seated in the rotated position) in order to engage the exterior surface of the grommets.

It is further envisioned that a related toggle design, as shown in FIG. 11, can be likewise reconfigured to include a magnet or adhesive backing and directly installed to the air intake face without the use of the channel members. It is also understood that any of the twist or toggle lock fastener designs described herein can also be constructed of a durable polymer material in addition to metal.

Having described my invention, other and additional preferred embodiments will become apparent to those skilled in the art to which it pertains and without deviating from the scope of the appended claims.

I claim:

1. An assembly for installing a covering with a plurality of aperture defining grommets over an air intake opening in engagement with a surrounding perimeter extending face, comprising:
a plurality of fasteners adapted to being affixed to the intake face, each of said fasteners having pedestal base and an extending post, an enlarged head portion constructed of a deflectable and resilient material configured atop said post; and
upon arraying the covering over the intake opening, said enlarged head portions are compressed during insertion through the grommets, said head portions re-expanding following passage through the grommets and adapting to abut against an exterior rim surface of the grommets to retain the cover in place over the intake opening.

2. The assembly as described in claim 1, said enlarged head portion further comprising a planar shaped portion.

3. The assembly as described in claim 2, said planar shaped portion including at least one of a circular, modified ellipsoidal, rectangular or triangular shape.

4. The assembly as described in claim 1, said enlarged head portion further comprising a bulbous head portion with an underside rim extending from said post.

5. The assembly as described in claim 1, said enlarged head portion further comprising a material including at least one of a durable polypropylene (PP), Polyethylene terephthalate (PET or PETE), High-density polyethylene (HDPE), Polyvinyl chloride (PVC), or a Low-density polyethylene (LDPE).

6. The assembly as described in claim 1, further comprising a magnet incorporated into an underside of said pedestal base of each of said fasteners.

7. The assembly as described in claim 1, further comprising an adhesive material incorporated into an underside of said pedestal base of each of said fasteners. The assembly as described in claim 1, further comprising a template sheet adapted to being temporarily located over the intake face in contact with the perimeter extending face prior to affixing said fasteners, a plurality of perimeter locations in said template sheet identifying placement locations for said pedestal base of each fastener.

9. The assembly as described in claim 9, said template sheet further comprising a tacky underside surface and being constructed of a thin ply flexible Mylar or paper material.

10. A fastener for installing a covering with a plurality of aperture defining grommets over an air intake opening in engagement with a surrounding perimeter extending face, comprising:
a body adapted to being affixed at a location of the intake face and having a pedestal base and an extending post;
an adhesive material incorporated into an underside surface of said pedestal base, a peel away tape layer covering a first surface of said adhesive material; and
upon affixing a plurality of said bodies to the intake face and arraying the covering over the intake opening, an engaging portion associated with each of said extending posts inserting through a selected one of the grommets and adapting to abut against an exterior rim surface of the grommet to retain the cover in place over the intake opening.

11. The fastener of claim 10, further comprising a carrier material over which is coated said adhesive material.

12. The fastener of claim 11, said carrier material further comprising any of a polymeric film, foam, paper, cloth or foil, coated with an acrylic, rubber or silicone.

13. The fastener of claim 10, further comprising a second peel away tape layer covering a second surface of said adhesive opposite said first surface for pre-mounting said adhesive to said fastener pedestal base prior to affixing said fastener to the intake face.

14. The fastener of claim 10, said engaging portion of said fastener further comprising an enlarged head portion constructed of a deflectable and resilient material configured atop said post such that said enlarged head portion is compressed during insertion through the grommet and re-expands following passage through the grommet.

15. The fastener of claim 14, said enlarged head portion further comprising a planar shaped portion.

16. The fastener of claim 15, said planar shaped portion including at least one of a circular, modified ellipsoidal, rectangular or triangular shape.

17. The fastener of claim 14, said enlarged head portion further comprising a bulbous head portion with an underside rim extending from said post.

18. The fastener of claim 14, said enlarged head portion further comprising a material including at least one of a durable polypropylene (PP), Polyethylene terephthalate (PET or PETE), High-density polyethylene (HDPE), Polyvinyl chloride (PVC), or a Low-density polyethylene (LDPE).

19. The fastener of claim 10, said engaging portion further comprising a twist lock portion.

20. The fastener of claim 10, said engaging portion further comprising a toggle lock portion.

21. An assembly kit for installing a covering with a plurality of aperture defining grommets over an air intake opening in engagement with a surrounding perimeter extending face, comprising:
a plurality of fasteners adapted to being affixed to the intake face, each of said fasteners having pedestal base and an extending post, an engaging portion associated with each of said extending posts;
a plurality of attachment accessories including at least one of a dual tape layer adhesive material or a single tape layer adhesive backed magnetic portion, said attachment accessories initially securing to either of an underside of each pedestal base or to the intake face prior to assembling the fasteners to the intake face; and
upon arraying the covering over the intake opening, said engaging portions being inserted through the grommets and adapting to abut against an exterior rim surface of the grommets to retain the cover in place over the intake opening.

22. The assembly kit of claim 21, further comprising a template sheet adapted to being temporarily located over he intake face in contact with the perimeter extending face prior to affixing said fasteners, a plurality of perimeter locations in said template sheet d placement locations for said pedestal base of each fastener.
